(19) United States
(12) Patent Application Publication
(10) Pub. No.: US 2013/0278578 A1
(43) Pub. Date: Oct. 24, 2013

(54) DISPLAY DEVICE AND MEANS TO IMPROVE LUMINANCE UNIFORMITY

(71) Applicants: Arnout Robert Leontine Vetsuypens, Denderbelle (BE); Wouter M.F. Woestenborghs, Wachtebeke (BE); Peter Nollet, Gent (BE)

(72) Inventors: Arnout Robert Leontine Vetsuypens, Denderbelle (BE); Wouter M.F. Woestenborghs, Wachtebeke (BE); Peter Nollet, Gent (BE)

(21) Appl. No.: 13/977,755

(22) PCT Filed: Jan. 2, 2012
(86) PCT No.: PCT/EP2012/050027

§ 371 Date: Jul. 1, 2013

(30) Foreign Application Priority Data
Dec. 31, 2010 (GB) 1022137.2

(51) Int. Cl. G09G 5/02

(52) U.S. Cl. CPC G09G 5/02
USPC 345/207

(57) ABSTRACT

A method and sensor system and software are described for use of at least two sensors for detecting a property such as the intensity, colour and/or colour point of light emitted from at least two display areas of a display device into the viewing angle of said display device, e.g. for real-time measurements, while the display is in use, and off-line measurements, namely when the normal display functionality is interrupted, with a high signal to noise ratio and a reduced amount of observed non-uniformities in the luminance. The sensors are substantially transparent. The entire area of the display is used for the measurements, which is the result of combining the contribution of the backlight and the panel, that both can exhibit luminance non-uniformities.

### FIELD OF THE INVENTION

The invention relates to a method and a display device having at least two sensors for detecting a property such as the intensity, colour and/or colour point of light emitted from at least two display areas of a display device into the viewing angle of said display device.

The invention also relates to software and a computer program comprising an algorithm to improve spatial luminance uniformity and/or spatial colour uniformity, in perpendicular direction to the display's active area.

### BACKGROUND OF THE INVENTION

In modern medical facilities high-quality medical imaging using display devices like liquid crystal display devices (LCD devices) is more important than ever before as a diagnostic tool, as they commonly used nowadays to make life-critical decisions. In addition, other display technologies from which crucial data is needed to be retrieved by human observers typically are provided with a sensor and a controller device coupled thereto. One type of sensor is coupled to a backlight device, for instance comprising light emitting diodes (LEDs) or Cold Cathode Fluorescent tubes (CCFLs), of the LCD device. It aims at stabilizing the output of the backlight device, which inherently varies as a consequence of the use of LEDs therein. While intensive quality control during the display's lifetime is of the utmost importance for diagnostic displays, displays used in other markets can also benefit from similar sensing techniques. An example is the broadcast market where luminance and color uniformity over the display's active area are essential.

During the display lifetime, the luminance output of the lamps will decrease continuouslyup to the point that the display will be unable to reach the desired luminance. In addition, not only does the value of the luminance output alter, but also the uniformity of the light output will alter over time, some areas of an active area can degrade slightly different than other, which results in a non-uniform behavior of the light output. On top of that, there can be a color shift with aging of the display. This can be a global, uniform shift over the entire display's active area, or this can be a spatially-dependant color shift. When this occurs, a signal is to be sent indicating that the display is no longer conform to the high-quality standards, and can therefore no longer be used, or should be adapted somehow such that it can again be used for the intended application.

Display systems which are matrix based or matrix addressed are composed of individual image forming elements, called pixels (Picture Elements), that can be driven (or addressed) individually by proper driving electronics. However, they suffer from significant noise, so called image noise. The driving signals can switch a pixel to a first state, the on-state (luminance emitted, transmitted or reflected) or to a second state, the off-state (no luminance emitted, transmitted or reflected). For some displays, one stable intermediate state between the first and the second state is used-see EP 462 619 which describes a LCD.

For still other displays, one or more intermediate states between the first and the second state (modulation of the amount of luminance emitted, transmitted or reflected) are used. A modification of these designs attempts to improve uniformity by using pixels made up of individually driven sub-pixel areas and to have most of the sub-pixels driven either in the on- or off-state-see EP 478 043 which also describes an LCD. One sub-pixel is driven to provide intermediate states. Due to the fact that this sub-pixel only provides modulation of the grey-scale values determined by selection of the binary driven sub-pixels the luminosity variation over the display is reduced.

A known image quality deficiency existing with these matrix based technologies is the unequal light-output response of the pixels that make up the matrix addressed display consisting of a multitude of such pixels. More specifically, identical electric drive signals to various pixels may lead to different light-output output of these pixels. Current state of the art displays have pixel arrays ranging from a few hundred to millions of pixels. The observed light-output differences between pixels of the display's active area can be as high as 40% (as obtained from the formula (minimum luminance-maximum luminance)/minimum luminance).

EP 0755042 describes a method and device for providing uniform luminosity of a field emission display (FED). Non-uniformities of luminance characteristics in a FED are compensated pixel by pixel. This is done by storing a matrix of correction values, one value for each pixel. These correction values are determined by a previously measured emission efficiency of the corresponding pixels. These correction values are used for correcting the level of the signal that drives the corresponding pixel.

It is a disadvantage of the method described in EP 0755042 that a linear approach is applied, i.e. that a same correction value is applied to a drive signal of a given pixel, independent of whether a high or a low luminance has to be provided. However, pixel luminance for different drive signals of a pixel depends on physical features of the pixel, and those physical features may not be the same for high or low luminance levels. Therefore, pixel non-uniformity is different at high or low levels of luminance, and if corrected by applying to a pixel drive signal a same correction value independent of the drive value corresponds to a high or to a low luminance level, non-uniformities in the luminance are still observed.

These differences in behavior are caused by various production processes involved in the manufacturing of the displays, and/or by the physical construction of these displays, each of them being different depending on the type of technology of the electronic display under consideration. As an example, for liquid crystal displays (LCDs), the application of rubbing for the alignment of the liquid crystal (LC) molecules, and the color filters used, are large contributors to the different luminance behavior of various pixels. The problem of lack of uniformity of OLED displays is discussed in US 20020047568. Such lack of uniformity may arise from differences in the thin film transistors used to switch the pixel elements.

### SUMMARY OF THE INVENTION

It is therefore an object of the present invention to provide an alternative method and sensor system and software for use at least two sensors for detecting a property such as the brightness uniformity, colour uniformity i.e. consistency of the display's chromaticity from at least two display areas of a display device into the viewing angle of said display device. The sensor system is designed to be integrated into the display permanently, without degrading the display's quality. The sensors can advantageously, due to their design, measure light output at various locations over a display's active area. A novel aspect of the present invention is the exact spatial configuration of the matrix of sensors and the appropriate way to either use the measured data to characterize the non-uniformity of the light or to interpolate the data to obtain a higher-resolution spatial light output map that can be used to correct the spatially non-uniform light output. By light output, typically luminance is meant but is can also include also chromaticity. Embodiments of the present invention provide a method to achieve this, namely it provides a way to spatially configure the sensor, and to use the measured data to either characterize or correct the non-uniformity of the light output of the display. The sensors are adapted to measure the light output at various locations, and the sensors use suitable signal and image processing techniques to process the acquired data appropriately to either characterize of the non-uniformity of the obtained data or take action on the driving of the display to improve the uniformity of the light output of the display.

Moreover, advantageous embodiments of the present invention can comprise a matrix of sensors that can measure and correct non-uniformities at a desired point in time. This is different than measuring the values upfront and storing them, which is done in typical prior art methodologies. In the present invention specific uniform images are also preferably used to measure and correct the uniformity.

According to a first aspect of the invention, a display device is provided that comprises at least two display areas provided with a plurality of pixels. In a preferred embodiment, for each display area a partially transparent sensor is provided for detecting a property of light emitted from the said display area into a viewing angle of the display device. The sensor is located in a front section of said display device in front of said display area.

Surprisingly good results have been obtained with at least partially transparent sensors located in front of the display area and within the viewing angle (i.e. in the light path originating from the display pixels, going to the eyes of the observer). An expected disturbance of the display image tends to be (almost) entirely absent. Due to the direct incoupling of the light into the sensor, proper light capturing by the sensor is achieved without a coupling member. Such transparent sensor can for instance be suitably applied to an inner face of a cover member.

Indeed, the transparent cover member may be used as a substrate in the manufacturing of the sensor. Particularly an organic or inorganic substrate has sufficient thermal stability to withstand operating temperature of vapor deposition, which is a preferred way of deposition of the layers constituting the sensor. Specific examples include chemical vapor deposition (CVD) and any type thereof for depositing inorganic semiconductors such as metal organic chemical vapor deposition (MOCVD) or thermal vapor deposition. In addition one can also apply low temperature deposition techniques such as printing and coating for depositing organic materials for instance. Another method, which can be used, is organic vapor phase deposition. When depositing organic materials, the temperatures at the substrate level are not much lower than any of the vapor deposition. Assembly is not excluded as a manufacturing technique. In addition, coating techniques can also be used on glass substrates, however for polymers one must keep in mind that the solvent can dissolve the substrate in some cases

In a suitable embodiment hereof, the device further comprises at least partially semitransparent electrical conductors for conducting a measurement signal from said sensor within said viewing angle for transmission to a controller. Substantially transparent conductor materials such as a tin oxide, e.g. indium tin oxide or a transparent polymeric material such as polymeric Poly(3,4-ethylenedioxythiophene) poly(styrenesulfonate), typically referred to as PEDOT:PSS, are well-known semitransparent electrical conductors. Preferably, a thin oxide or transparent conductive oxide is used, for instance zinc oxide can also be used which is known to be a good transparent conductor. In one most suitable embodiment, the sensor is provided with transparent electrodes that are defined in one layer with the said conductors (also called a lateral configuration). This reduces the number of layers that inherently lead to additional absorption and to interfaces that might slightly disturb the display image.

In the preferred embodiment, the sensor comprises an organic photoconductor. Such organic materials have been a subject of advanced research over the past decades. Organic photoconductive sensor may be embodied as single layers, as bilayers and as general multilayer structures. They may be advantageously applied within the present display device. Particularly, the presence on the inner face of the cover member allows that the organic materials are present in a closed and controllable atmosphere, e.g. in a space between the cover member and the display, which will provide protection from any potential external damaging. A getter may for instance be present to reduce negative impact of humidity and oxygen. An example of a getter material is CaO. Furthermore, vacuum conditions or a predefined atmosphere (for instance pure nitrogen, an inert gas) may be applied in said space upon assembly of the cover member to the display, i.e. an encapsulation of the sensor.

A sensor comprising an organic photoconductive sensor suitably further comprises a first and a second electrode that advantageously are located adjacent to each other. The location adjacent to each other, preferably defined within one layer, allows a design with finger-shaped electrodes that are mutually interdigitated. Herewith, charges generated in the photoconductive sensor are suitably collected by the electrodes. Preferably the number of fingers per electrode is larger than 50, more preferably larger than 100, for instance in the range of 250-2000. But this is not a limitation of this invention.

Furthermore an organic photoconductive sensor can be a mono layer, a bi-layer or in general a multiple (>2) layer structure. In one preferred type of photosensor is one wherein the organic photoconductive sensor is a bilayer structure with a exciton generation layer and a charge transport layer, said charge transport layer being in contact with a first and a second electrode. Such a bilayer structure is for instance known from Applied Physics Letters 93 “Lateral organic bilayer heterojunction photoconductors” by John C. Ho, Alexi Arango and Vladimir Bulovic. The sensor described by J. C. Ho et al relates to a non-transparent sensor as it refers to gold electrodes which will absorb the impinging light entirely. The bilayer comprises an EGL (PTCBI) or Exciton Generation Layer and a HTL (TPD) or Hole Transport Layer (HTL) (in contact with the electrodes).

Alternatively, sensors comprising composite materials can be constructed. With composite materials nano/micro particles are proposed, either organic or inorganic dissolved in the organic layers, or an organic layer consisting of a combination of different organic materials (dopants). Since the organic photosensitive particles often exhibit a strongly wavelength sensitive absorption coefficient, this configuration can result in a less colored transmission spectrum when suitable materials are selected and suitably applied, or can be used to improve the detection over the whole visible spectrum, or can improve the detection of a specific wavelength region. Alternatively, instead of using organic layers to generate charges and collect them with the electrodes, hybrid structures using a mix of organic and inorganic materials can be used. A bilayer device that uses a quantum-dot exciton generation layer and an organic charge transport layer can be used. For instance colloidal Cadmium Selende quantum dots and an organic charge transport layer comprising of Spiro-TPD.

Although the preferred embodiment, which uses organic photoconductive sensors allowed obtaining good results, a disadvantage could be that the sensor only provides one output current per measurement for the entire spectrum. In other words, it is not evident to measure color online while using the display. This could be avoided by using three independent photoconductors that measure red, green and blue independently, and provide a suitable calibration for the three independent photoconductors. They could be conceived similarly to the previous descriptions, and stacked on top of each other, or adjacent to each other on the substrate, to obtain an online color measurement. Offline color measurements can be made without the three independent photoconductors, by calibrating the sensor to an external sensor which is able to measure tristimulus values (X, Y & Z), for a given spectrum. It is important to note that uniform patches should be displayed here, as will become clear from the later description of the methodology to measure online.). This can be understood as follows. A human observer is unable to distinguish the brightness or chromaticity of light with a specific wavelength impinging on his retina. Instead, he possesses three distinct types of photoreceptors, sensitive to three distinct wavelength bands that define his chromatic response. This chromatic response can be expressed mathematically by color matching functions. Consequentially, three color matching functions, and have been defined by the CIE in 1931. They can be considered physically as three independent spectral sensitivity curves of three independent optical detectors positioned at our retinas. These color matching functions can be used to determine the CIE1931 XYZ tristimulus values, using the following formulae:

X=∫₀^{∞}I(λ) x̅(λ)dλ

Y=∫₀^{∞}I(λ) y̅(λ)dλ

Z=∫₀^{∞}I(λ) z̅(λ)dλ

Where I (λ) is the spectral power distribution of the captured light. The luminance corresponds to the Y component of the CIE XYZ tristimulus values. Since a sensor, according to embodiments of the present invention, has a characteristic spectral sensitivity curve that differs from the three color matching functions depicted above, it cannot be used as such to obtain any of the three tristimulus values. However, the sensor according to embodiments of the present invention is sensitive in the entire visible spectrum with respect to the absorption spectrum of the sensor (or alternatively, they are at least sensitive to the spectral power distributions of a (typical) display's primaries), which allows obtaining the XYZ values after calibration for any specific type of spectral light distribution emitted by our display. Displays are typically either monochrome or color displays. In the case of monochrome (e.g. grayscale) displays, they only have a single primary (e.g. white), and hence emit light with a single spectral power distribution. Color displays have typically three primaries—red (R), green (G) and blue (B)—which have three distinct spectral power distributions. A calibration step preferably is applied to match the XYZ tristimulus values corresponding to the spectral power distributions of the display's primaries to the measurements made by the sensor according to embodiments of the present invention. In this calibration step, the basic idea is to match the XYZ tristimulus values of the specific spectral power distribution of the primaries to the values measured by the sensor, by capturing them both with the sensor and an external reference sensor. Since the sensor according to embodiments of the present invention is non-linear, and the spectral power distribution associated with the primary may alter slightly depending on the digital driving level of the primary, it is insufficient to match them at a single level. Instead, they need to be matched ideally at every digital driving level. This will provide a relation between the actual tristimulus values and sensor measurements in the entire range of possible values. To obtain a conversion between any measured value, as measured by the sensor according to the preferred embodiment, and the desired tristimulus value, an interpolation is needed to obtain a continuous conversion curve. This results in three conversion curves per display primary that convert the measured value in the XYZ tristimulus values. In the case of a monochrome display, three conversion curves are obtained when using this calibration methodology. Obtaining the XYZ tristimulus values is now evident when using a monochrome display. The light to be measured can simply be generated on the display (in the form of uniform patches), and measured by the sensor according to embodiment of the present invention, when using the different conversion curves.

In the case of a color display, this calibration needs to be done for each of the display's primaries. This results in 9 conversion curves, in the typical case when the display has 3 primaries. Note that a specific colored patch with a specific driving of the red, green and blue primary will have a specific spectrum, which is a superposition of the scaled spectra of the red, green and blue primaries, and hence every possible combination of the driving levels needs to be calibrated individually. Therefore, an alternative methodology can suitably be used: the red, green and blue primaries need to be calibrated individually for each digital driving level. During such a calibration a single primary patch is displayed while the other 2 channels (primaries) remain at the lowest possible driving level (emitting the least possible light, ideally no light at all). This suitable methodology implies that the red, green and blue driving of the patch needs to be done sequentially. The correct three conversion curves corresponding to the specific primary will need to be applied to obtain the XYZ tristimulus values from the measured values. This results in three sets of tristimulus values: (XRYRZR), (XGYGZG) and (XBYBZB). Since the XYZ tristimulus values are additive, the XYZ tristimulus values of the patch can be obtained using the following formulae:

Xpatch=XR+XG+XB

Ypatch=YR+YG+YB

Zpatch=ZR+ZG+ZB

Note that we assume the display has no crosstalk in these formulae. Two parts can be distinguished in the XYZ tristimulus values. Y is directly a measure of brightness (luminance) of a color. The chromaticity, on the other hand, can be specified by two derived parameters, x and y. These parameters can be obtained from the XYZ tristimulus values using the following formulae:

$$x = \frac{X}{X + Y + Z}$$

$$y = \frac{Y}{X + Y + Z}$$

This offline color measurement which is enabled by calibrating the sensor to an external sensor which is able to measure tristimulus values (X, Y & Z) Thus allows measuring brightness as well as chromaticity.

The display defined in the at least two display areas of the display device may be of conventional technology, such as a liquid crystal device (LCD) with a backlight, for instance based on light emitting diodes (LEDs), or an electroluminescent device such as an organic light emitting diodes (OLED). The display device suitably further comprises an electronic driving system and a controller receiving electrical measurement signals generated in the at least two sensors and controlling the electronic driving system on the basis of the received electrical measurement signals.

According to other embodiments of the invention, a display device is provided that comprises at least two display areas with a plurality of pixels. For each display area, a sensor and an at least partially transparent optical coupling device are provided. The at least two sensors are designed for detecting a property of light emitted from the said display area into a viewing angle of the display device. The sensor is located outside or at least partially outside the viewing angle. The at least partially transparent optical coupling device is located in a front section of said display device. It comprises a light guide member for guiding at least one part of the light emitted from the said display area to the corresponding sensor. The coupling device further comprises an incoupling member for coupling the light into the light guide member.

It is an advantage of the present invention to detect a property such as the brightness or the chromaticity of light emitted by at least two display areas of a display device into the viewing angle of said display device without notably degrading the display device's image quality. The use of the incoupling member solves the apparent contradiction of a waveguide parallel to the front surface that does not disturb a display image, and a signal-to-noise ratio sufficiently high for allowing real-time measurements. An additional advantage is that any scattering eventually occurring at or in the incoupling member, is limited to a small number of locations over the front surface of the display image. However, when using waveguides a moiré pattern can be observed at the edge of the waveguides, which can be considered to be a high risk, to lower this risk the described embodiments using organic photoconductive sensors can be applied.

Preferably, the light guide member is running in a plane which is parallel to a front surface of the display device. The incoupling member is suitably an incoupling member for laterally coupling the light into the light guide member of the coupling device. The result is a substantially planar incoupling member. This has the advantage of minimum disturbance of displayed images. Furthermore, the coupling device may be embedded in a layer or plate. It may be assembled to a cover member, i.e. front glass plate, of the display after its manufacturing, for instance by insert or transfer moulding. Alternatively, the cover member is used as a substrate for definition of the coupling device.

In one implementation, a plurality of light guide members is arranged as individual light guide members or part of a light guide member bundle. It is suitable that the light guide member is provided with a circular or rectangular cross-sectional shape when viewed perpendicular to the global propagation direction of light in the light guide member. A light guide with such a cross-section may be made adequately, and moreover limits scattering of radiation. The cover member is typically a transparent substrate, for instance of glass or polymer material.

In any of the above embodiments the sensor or the sensors of the sensor system is/are located at a front edge of the display device.

The incoupling member of this embodiment may be present on top of the light guide member or effectively inside the light guide member. One example of such location inside the light guide is that the incoupling member and the light guide member have a co-planar ground plane. The incoupling member may then extend above the light guide member or remain below a top face of the light guide member or be coplanar with such top face. Furthermore, the incoupling member may have an interface with the light guide member or may be integral with such light guide member

In one particular embodiment, the or each incoupling member is cone-shaped. The incoupling member herein has a tip and a ground plane. The ground plane preferably has circular or oval shape. The tip is preferably facing towards the display area.

The incoupling member may be formed as a laterally prominent incoupling member. Most preferably, it is delimited by two laterally coaxially aligned cones, said cones having a mutual apex and different apex angles. The difference between the apex angles Δα=α1−α2 is smaller than the double value of the critical angle (θ_{c}) for total internal reflection (TIR) Δα<2θ_{c}. Especially, the or each incoupling member fades seamlessly to the guide member of the coupling device. The or each incoupling member and the or each guide member are suitably formed integrally.

In an alternative embodiment, the or each incoupling member is a diffraction grating. The diffraction grating allows that radiation of a limited set of wavelengths is transmitted through the light guide member. Different wavelengths (e.g. different colours) may be incoupled with gratings having mutually different grating periods. The range of wavelengths is preferably chosen so as to represent the intensity of the light most adequately.

In a further embodiment hereof, both the cone-shaped incoupling member and diffraction grating are present as incoupling members. These two different incoupling members may be coupled to one common light guide member or to separate light guide members, one for each, and typically leading to different sensors.

By using a first and a second incoupling members of different type on one common light guide member, light extraction, at least of certain wavelengths, may be increased, thus further enhancing the signal to noise ratio. Additionally, because of the different operation of the incoupling members, the sensor may detect more specific variations.

By using a first and a second incoupling member of different type in combination with a first and a second light guide member respectively, the different type of incoupling members may be applied for different type of measurements. For instance, one type, such as the cone-shaped incoupling member, may be applied for luminance measurements, whereas the diffraction grating or the phosphor discussed below may be applied for color measurements. Alternatively, one type, such as the cone-shaped incoupling member, may be used for a relative measurement, whereas another type, such as the diffraction grating, is used for an absolute measurement. In this embodiment, the one incoupling member (plus light guide member and sensor) may be coupled to a larger set of pixels than the other one. One is for instance coupled to a display area comprising a set of pixels, the other one is coupled to a group of display areas.

In a further embodiment, the incoupling member comprises a transformer for transforming a wavelength of light emitted from the display area into a sensing wavelength. The transformer is for instance based on a phosphor. Such phosphor is suitably locally applied on top of the light guiding member. The phosphor may alternatively be incorporated into a material of the light guiding member. It could furthermore be applied on top of another incoupling member (e.g. on top of or in a diffraction grating or a cone-shaped member or another incoupling member).

The sensing wavelength is suitably a wavelength in the infrared range. This range has the advantage the light of the sensing wavelength is not visible anymore. Incoupling into and transport through the light guide member is thus not visible. In other words, any scattering of light is made invisible, and therewith disturbance of the emitted image of the display is prevented. Such scattering typically occurs simultaneously with the transformation of the wavelength, i.e. upon reemission of the light from the phosphor. The sensing wavelength is most suitably a wavelength in the near infrared range, for instance between 0.7 and 1.0 micrometers, and particularly between 0.75 and 0.9 micrometers. Such a wavelength can be suitably detected with a commercially available photodetectors, for instance based on silicon.

A suitable phosphor for such transformation is for instance a Manganese Activated Zinc Sulphide Phosphor. Preferably, the phosphor is dissolved in a waveguide material, which is then spin coated on top of the substrate. The substrate is typically a glass substrate, for example BK7 glass with a refractive index of 1,51. Using lithography, the parts are removed from the which are undesired. Preferably, a rectangle is constructed which corresponds to the photosensitive area, in addition the remainder of the waveguide, used to transport the generated optical signal towards the edges, is created in a second iteration of this lithographic process. Another layer can be spin coated (without the dissolved phosphors) on the substrate, and the undesired parts are removed again using lithography. Waveguide materials from Rohm&Haas can be used or PMMA.

Such a phosphor may emit in the desired wavelength region, where the manganese concentration is greater than 2%. Also other rare earth doped zinc sulfide phosphors can be used for infrared (IR) emission. Examples are ZnS:ErF3 and ZnS:NdF3 thin film phosphors, such as disclosed in J. Appl. Phys. 94 (2003), 3147, which is incorporated herein by reference. Another example is ZnS:TmₓAg_{y}, with x between 100 and 1000 ppm and y between 10 and 100 ppm, as disclosed in U.S. Pat. No. 4,499,005.

The display device suitably further comprises an electronic driving system and a controller receiving optical measurement signals generated in the at least two sensors and controlling the electronic driving system on the basis of the received optical measurement signals.

The display defined in the at least two display areas of the display device may be of conventional technology, such as an liquid crystal device (LCD) with a backlight, for instance based on light emitting diodes (LEDs), or an electroluminescent device such as an organic light emitting (OLED) diodes.

Instead of being an alternative to the before mentioned transparent sensor solution, the present sensor solution of coupling member and sensor may be applied in addition to such sensor solution. The combination enhances sensing solutions and the different type of sensor solutions have each their benefits. The one sensor solution may herein for instance be coupled to a larger set of pixels than another sensor solution.

While the foregoing description refers to the presence of at least two display areas with a corresponding sensor solution, the number of display areas with a sensor is preferably larger than two, for instance four, eight or any plurality. It is preferable that each display area of the display is provided with a sensor solution, but that is not essential. For instance, merely one display area within a group of display areas could be provided with a sensor solution.

In a further aspect according to the invention, use of the said display devices for sensing a light property while displaying an image is provided.

Most suitably, the real-time detection is carried out for the signal generated by the sensor according to the preferred embodiment of this invention, this signal is generated according to the sensors' physical characteristics as a consequence of the light emitted by the display, according to its light emission characteristics for any displayed pattern. The detection of luminance and color (chromaticity) aspects may be carried out in a calibration mode, e.g. when the display is not in a display mode.

However, it is not excluded that luminance and chromaticity detection may also be carried out real-time, in the display mode. In some specific embodiments, it can be suitable to do the measurements relative to a reference value.

In the preferred embodiment of this invention, the sensor does not exhibit the ideal spectral sensitivity according to the V (λ) curve, nor does it have suitable color filters to measure the tristimulus values. Therefore, real-time measurements are difficult as the sensor will not be calibrated for every possible spectrum that results from the driving of the R, G & B subpixels which generate light impinging on the sensor. A V(λ) sensor following a V(λ) curve describes the spectral response function of the human eye in the wavelength range from 380 nm to 780 nm and is used to establish the relation between the radiometric quantity that is a function of wavelength λ, and the corresponding photometric quantity. As an example, the photometric value luminous flux is obtained by integrating radiant power φe (λ) as follows:

$${Φ}_{v} = {K}_{m} {\int }_{360 nm}^{780 nm} {Φ}_{e} ( λ ) \cdot V ( λ ) d λ$$

The unit of luminous flux φv is lumen [lm], the unit of φe is Watt [W] and for V(λ) is [1/nm]. The factor Km=683 lm/W establishes the relationship between the (physical) radiometric unit watt and the (physiological) photometric unit lumen. All other photometric quantities are also obtained from the integral of their corresponding radiometric quantities weighted with the V(λ) curve.

| | | Unit |
|---|---|---|
| Radiometery | | |
| Radiant power | Φe | W |
| Radiant intensity | Ie | W/sr |
| Irradiance | Ee | W/m² |
| Radiance | Le | W/m² sr |
| Photometry | | |
| Luminous flux | Φv | Lm |
| Luminous intensity | Iᵥ | Lm/sr = cd |
| Illuminance | Eᵥ | Lm/m² = lx |
| Luminance | Lᵥ | cd/m² |

It is clear from the explanation above, that measurements of luminance and illuminance require a spectral response that matches the V(λ) curve as closely as possible. In general, a sensor according to embodiments of the present invention, is sensitive to the entire visible spectrum and doesn't have a spectral sensitivity over the visible spectrum that matches the V(λ) curve. Therefore, an additional spectral filter is needed to obtain the correct spectral response.

On top of this non-ideal spectral sensitivity, the sensor as described in a preferred embodiment also does not operate as an ideal luminance sensor.

As the sensor used is not a perfect luminance sensor, as it does not only capture light in a very small opening angle, preferably the angular sensitivity is taken into account, as described in the following part.

For a given point on an ideal luminance sensor, the measured luminance corresponds to the light emitted by the pixel located directly under it (assuming that the sensor's sensitive area is parallel to the display's active area). On the contrary, the sensor according to embodiments of the present invention captures the pixel under the point together with some light emitted by surrounding pixels. More specifically, the values captured by the sensor cover a larger area than the size of the sensor itself. Because of this, the patterns used, do not correspond to the actual patterns and therefore a correction has to be done in order to simulate the measurements of the sensor. To enable the latter preferably the luminance emission pattern of a pixel is measured as a function of the angles of its spherical coordinates, represented in Figure a. The range of the angles preferably are changed from −80 to 80 degrees with a step of 2 degrees for the inclination angle θ and from 0 to 180 with a step of 5 degrees for the angle φ. The distance preferably is kept constant over the measurements. When a luminance sensor is positioned parallel to the display's active area, the latter corresponds to an inclination angle of 0, meaning that only an orthogonal light ray is considered. In addition, the exact light sensitivity of the sensor can be characterized. These measurements can then be used in the optical simulation software to obtain the corrected pattern for the actual light the sensors will detect. Using this actual light output will provide an additional improvement and advantageous effect of the algorithm that will render more reliable results.

As a result, for an appropriate real-time sensing while display of images is ongoing, further processing on sensed values is suitably carried out. Therein, an image displayed in a display area is used for treatment of the corresponding sensed value or sensed values, as well as the sensor's properties. Aspects of the image that are taken into account, are particularly its light properties, and more preferably light properties emitted by the individual pixels or an average thereof. Light properties of light emitted by individual pixels include their emission spectrum at every angle,

An algorithm may be used to calculate the expected response of the sensor, based on digital driving levels provided to the display, and the physical behavior of the sensor (this includes its spectral sensitivity over angle, its non-linearities and so on). When comparing the result of this algorithm to the actually measured light of a pixel or a group of pixels, it is possible to improve the display's performance by implementing a precorrection on the display's driving levels to obtain the desired light output. This precorrection may be an additional precorrection which can be added onto a precorrection that for example corrects the driving of the display such that a uniform light output over the display's active area is obtained.

In one embodiment, the difference between the sensing result and the theoretically calculated is compared by a controller to a lower and/or an upper threshold value, taking into account the reference. If the result is outside the accepted range of values, it is to be reviewed or corrected. One possibility for review is that one or more subsequent sensing results for the display area are calculated and compared by the controller. If more than a critical number of sensing values for one display area are outside the accepted range, then the setting for the display area is to be corrected so as to bring it within the accepted range. A critical number is for instance 2 out of 10. E.g. if 3 to 10 of sensing values are outside the accepted range, the controller takes action. Else, if the number of sensing values outside the accepted range is above a monitoring value but not higher than the critical value, then the controller may decide to continue monitoring.

In order to balance processing effort, the controller may decide not to review all sensing results continuously, but to restrict the number of reviews to infrequent reviews with a specific time interval in between. Furthermore, this comparison process may be scheduled with a relatively low priority, such that it is only carried out when the processor is idle.

In another embodiment, such sensing result is stored in a memory. At the end of a monitoring period, such set of sensing results may be evaluated. One suitable evaluation is to find out whether the sensed values of the difference in light are systematically above or below the threshold value that, according to the settings specified by the driving of the display, should be emitted. If such systematic difference exists, the driving of the display may be adapted accordingly. In order to increase the robustness of the set of sensing results, certain sensing results may be left out of the set, such as for instance an upper and a lower value. Additionally, it may be that values corresponding to a certain display setting are looked at. For instance, sensing values corresponding to a high (RGB) driving levels are looked at only. This may be suitable to verify if the display behaves at high (RGB) driving levels similar to its behaviour at other settings, for instance low (RGB) driving levels. Alternatively, the sensed values of certain (RGB) driving level settings may be evaluated as these values are most reliable for reviewing driving level settings. Instead of high and low values, one may think of light measurements when emitting a predominantly green image versus the light measurements when emitting a predominantly yellow image.

Additional calculations can be based on said set of sensed values. For instance, instead of merely determining a difference between sensed value and theoretically calculated value of the light output, which is the originally calibrated value, the derivative may be reviewed. This can then be used to see whether the difference increases or decreases. Again, the timescale of determining such derivative may be smaller or larger, preferably larger, than that of the absolute difference. It is not excluded that average values are used for determining the derivative over time.

In another use, sets of sensed values, at a uniform driving of the display (or when applying another precorrection dedicated to achieve a uniform luminance output), for different display areas are compared to each other. In this manner, homogeneity of the display emittance (e.g. luminance) can be calculated.

It will be understood by the skilled reader, that use is made of storage of displays theoretically calculated values and sensed values for the said processing and calculations. An efficient storage protocol may be further implemented by the skilled person.

In the embodiment the display is used in a room with ambient light, the sensed value is suitably compared to a reference value for calibration purposes. The calibration will be typically carried out per display area. In the case of using a display with a backlight, the calibration typically involves switching the backlight on and off to determine potential ambient light influences that might be measured during normal use of the display, for a display area and suitably one or more surrounding display areas. The difference between these measured values corresponds to the influence of the ambient light. This value needs to be determined because otherwise the calculated ideal value and the measured value will never match when the display is put in an environment that is not pitch black. In case of using a display without backlight, the calibration typically involves switching the display off, within a display area and suitably surrounding display areas. The calibration is for instance carried out for a first time upon start up of the display. It may subsequently be repeated for display areas. Moments for such calibration during real-time use which do not disturb a viewer, include for instance short transition periods between a first block and a second block of images. In case of consumer displays, such transition period is for instance an announcement of a new and regular program, such as the daily news. In case of professional displays, such as displays for medical use, such transition periods are for instance periods between reviewing a first medical image (X-ray, MRI and the like) and a second medical image. The controller will know or may determine such transition period.

In another preferred embodiment, at least two sensors can be used over at least two areas of the display, while displaying an image that is intended to result in a uniform light output (e.g. all digital driving levels are made equal in the case no precorrection table is applied to the display's driving). Typically, for luminance uniformity corrections, the measurements are made on white patterns, for instance with equal driving of the red, green and blue sub pixels when using a color display.

As mentioned before, the sensor as described in the preferred embodiments is not an ideal sensor. Therefore, a calibration is required to perform accurate measurements using the device. In this calibration, the entire luminance range that can be generated by the display needs to be included, as the sensor can also behave non-linearly depending on the brightness of the impinging light, and the spectrum might slightly alter towards the darker levels. The calibration can be done for example by upfront measuring the pattern twice, once using a sensor according to the present invention, and once using a reference luminance meter with a narrow viewing angle. In the case uniform patterns are applied, the mathematical algorithm elaborated earlier is less essential, which is obvious for the reader skilled in the art, and the issues can be overcome by calibrating the sensor to an external reference sensor. An example of a reference luminance meter is the Minolta CA-210. Once both measurements have been obtained, a look-up table can be created that contains scaling factors for the values measured by the sensor. Using this look-up table each time a uniformity check is executed, the correct luminance values can be obtained. Similar calibrations can be done for the X and Z tristimulus values, which can than be used for chromaticity measurements.

Using another method, sensors can be designed in a matrix of areas, such as squares of 1 cm by 1 cm sensors. Similar to the previous methodology, the sensors need to be calibrated to an external reference sensor. This will however require a design with a significant amount of transparent conductive tracks such as ITO tracks, as the two finger electrodes reside in the same plane. To limit the number of transparent conductive tracks such as ITO tracks, one of the fingers can always be connected to a central connector, which corresponds to the ground potential. The other electrodes are designed to converge to the different connections of a multiplexer, allowing switching between the different sensors. This will allow the sensing area to be as large as possible, with a minimal amount potential sensing area lost to the transparent conductive tracks such as ITO tracks.

As a result the luminance measurement at different areas over the active area can give an indication of the luminance non-uniformity of the screen, e.g. when the display is set to a specific pattern or when the display is set to uniform luminosity. Simple luminance checks can be performed at different positions, depending on the critical points or most representative areas of the display design. The specifications regarding luminance uniformity can be derived from established standards/recommendations, e.g. created by dedicated committees and expert groups. An example of a standard created by TG18 can be the following: luminance is measured at five locations over the faceplate of the display device (centre and four corners) using a calibrated luminance meter. If a telescopic luminance meter is used, it may need to be supplemented with a cone or baffle. For display devices with non-Lambertian light distribution, such as an LCD, if the measurements are made with a near-range luminance meter, the meter should have a narrow aperture angle, otherwise certain correction factors should be applied (Blume et al. 2001).

As a result, luminance uniformity is determined by measuring luminance at various locations over the face of the display device while displaying a uniform pattern. Non-uniformity can be quantified as the maximum relative luminance deviation between any pair or set of luminance measurements. Alternatively, a metric of spatial non-uniformity may also be calculated as the standard deviation of luminance measurements, for instance within 1-1 cm regions across the faceplate divided by the mean. This regional size approximates the area at a typical viewing distance. Non-uniformities in CRTs and LCDs may vary significantly with luminance level, so a sampling of several luminance levels is usually necessary to characterise luminance uniformity.

Using this standard as a guideline, a sensor design can be implemented. In a first method, the sensor-layout design is such that five sensors are created: one in the centre and four corners. Of course other custom sensor designs with very specific parameters are also possible. For example, when the exact size of the measurement area is not specified, only the borders of the region are specified. Creating a sensor with a large sensing area is preferred, since this will average out any high-frequency spatial non-uniformity which might occur in the region. This can be realized in practice when using the preferred embodiment comprising organic photoconductive sensors by using electrode finger patterns with longer fingers and more fingers, or alternatively multiple smaller sensors which can be combined to create an averaged measurement. As a uniform pattern needs to be applied to the display, the measurements cannot be made during normal use of the display. Instead, the patterns can be displayed when an interruption of the normal image content is permitted.

Alternatively, the luminance uniformity can be quantified using the following formula: 200*(Lmax−Lmin)/(Lmax+Lmin). Depending on the outcome of the measurements, it can be validated if the display is still operating within tolerable limits or not. If the performance proves to be insufficient, a signal can be sent to an administrator, or to an online server that registers the performance of the display over time.

In addition, continuous recording of the outputs of the luminance performance can result in digital water marking, e.g. after capturing and recording all the signals measured by all the sensors of the sensor system at the time of diagnosis, it could be possible to re-create the same conditions which existed when an image was used to perform the diagnosis, at a later date.

The spatial noise display of the display light output can also be characterized based by calculating the NPS (Noise Power Spectrum) of measurements of a uniform pattern at different digital driving levels.

Aside from a mere detection of the non-uniformity, luminance of color non-uniformities can be corrected. In the following, we focus on luminance uniformity corrections, but it is clear for anyone skilled in the art that this can be extended to color uniformity corrections for instance by altering the relative driving of the red, green and blue channels of a color display, and applying luminance uniformity corrections afterwards by while maintaining the relative driving of the red, green and blue channels, in case the display has a linear luminance in a driving level curve, or alternatively adapt the ratio according to the actual luminance vs driving level curve. This might require several iterations to obtain a satisfactory result.

Typical luminance uniformity correction algorithms measure the luminance non-uniformity during production and, based on the measured results, apply a precorrection table to the driving levels of the display. This correction can be either based on an individual pixel basis or on a by using a correction per zone.

Another aspect of the invention is to use a matrix of semitransparent organic sensors to capture a low resolution luminance map of the light emitted by the display when all the pixels are put to an equal driving level. This would allow to derive a new precorrection table during calibration.

Using only a limited number of sensors, the global trend of the non-uniformity profile can be corrected. In addition, from measurements it can be observed that the main non-uniformities are present toward the edges and that two components of noise can be distinguished from the measurements: a high frequency noise, which is typically Gaussian, and low frequency noise resulting in the global trend of the curve.

Determining the best solution of the luminance map depends on several factors, as there are a wide range of design parameters and a lot of flexibility to choose from. For example, only few constraints apply to the positioning of the sensors; the most important being that two sensors cannot overlap. Otherwise, sensors can be located at any position on the display. Several main design parameters of the sensors can be altered to obtain the most optimal results:

(1) size: the sensors are preferably large enough to cancel out the high-frequency Gaussian noise. Since the measured data is a spatial average of the light impinging on the sensor, the noise will indeed disappear. However, the sensors should not be too large, otherwise we may cancel out the low-frequencies as well and the sensors would not capture the correct signal anymore. This is an additional flexibility of the preferred embodiment which uses organic photoconductive sensors: the freedom to alter some of the design parameters (e.g. the number of fingers of the electronic conductor and the possibility to modify the size of the sensor)

(2) position of sensors: the sensors are preferably located on the whole area of the display and their positions will define a 2D grid. This grid may be uniform or not, regular over the display or not. For instance, the spacing in the borders may be reduced while keeping a uniform grid in the centre of the display.

(3) number of sensors: the basic trade-off concerning the number of sensors is the cost of the sensor, more sensors will certainly result in better-fitting curves, but can typically result in a higher cost, for example due to more elaborate driving electronics. Moreover, the resulting improvement can be limited; there is typically an asymptotic behaviour at depending on the number of sensors used.

(4) Moreover, the interpolation/approximation method used is of great importance. This will determine, based on the measurements of the sensors, the curve that will be used for correction. Of course, given a set of points an infinite number of possibilities can be used to link them together or approximate them. A preferred approximation algorithm which is used is an interpolation method which is based on biharmonic spline interpolation as disclosed by Sandwell et al in “Biharmonic Spline Interpolation of GEOS-3 and SEASAT Altimeter Data”, Geophysical Research Letters, 2, 139-142, 1987. The biharmonic spline interpolation finds the minimum curvature interpolating surface, when a non-uniform grid of data points is given. Other approximation algorithms can also be used, for example, the B-Spline which is disclosed in H. Prautzsch et al, Bézier-and B-Spline techniques, Spinger (2010). Other interpolation and approximation techniques can also be applied. For instance an interpolating curve can be defined by a set of points, which runs through all of them. An approximation defined on the set of points, also called control point, will not necessarily interpolate every point and possibly none of them. An additional property is that the control points are connected in the given order. Preferably, the set of control points is assumed to be ordered according to their abscissa, although it is not mandatory to apply the interpolation technique in the general case. Another interpolation method which can be applied is linear interpolation, where a set of control points is given and whereby the interpolating curve is the union of the line segment connecting two consecutive points. The linear interpolation is an easy interpolation technique and is continuous. However, it is a local technique, since moving a single point will influence only two line segments, hence will not propagate to the entire curve. Another technique which can be applied is a cubic spline interpolation, whereby cubic piecewise polynomials are used. The cubic spline has the particularity that both the first and second derivatives are continuous, resulting in a smooth curve. This technique is global since moving a point influences the entire curve. The Catmull-Rom interpolation can also be used, which is a special case of the pchip interpolation, where the slope of the curve leaving a point is the same as the slope of the segment connecting the previous and the next control points. In addition, the first derivative is continuous.

(5) The algorithm used will be compared to the original data and their quality will be assessed using a metric. The metric preferably permits to assess the quality of the approximation. The easiest is to use purely objective metrics, such as PSNR and MSE, computing for instance the absolute difference between the two signals (or the actual obtained signal after the correction based on the interpolation/approximation and an ideal uniform reference pattern), maximum local and global percentual error. The global percentual error can for instance be obtained by calculating the local percentual error per pixel, and averaging it for the entire area under consideration. However, the generated results are not necessarily the most consistent ones with what perception human observer would perceive. Therefore, subjective metrics based on the human visual system have been created, that allow obtaining a better match how the image is perceived by humans. For example, we can use the Structural Similarity (SSIM) index, which is based on the human visual system, and can be used to compare the similarity between two images. In our application, one of the images is typically the ideal uniform reference image, which should ideally be obtained after calibration.

(6) In addition, borders present in the device provide the largest non-uniformities and complex effects occur. For instance, the natural drop-off of the luminance is partly compensated by the mach-banding phenomenon. Indeed, as a consequence of the mach-banding phenomenon, a more uniform luminance profile is perceived. On top of that, creating the sensors with a very tiny width has no use as the high-frequency trend will no longer be filtered out, which is undesired. Therefore, the analysis is typically limited to a certain percentage of the display area, excluding the very edge of the display borders. This percentage is an extra parameter and would for instance lie between 95 and 99%.

In addition a self-optimizing algorithm can be applied, since there are various parameters which can be fine-tuned, the final optimal solution is a combination of choices for each parameter. Unfortunately, the parameters may not be independent, meaning that for instance the optimal size of the sensors will depend on their number and on their positioning. Hence, a self-optimizing algorithm designed such that it automatically looks for a suitable range of parameters, or more precisely a combination of parameters, is very useful. This is very advantageous as we can then apply it to any kind of spatial noise pattern later on, suitable parameters will be determined automatically. This algorithm can be based on an iterative approach that tests all possible combinations of all parameters in a suitable range, and applies the metric to determine the quality of the result, based on a number of representative images for the display that should be made uniform. Once the results have been obtained for all combinations, a suitable result can be selected. The selection can be based on various criteria, such as complexity, cost, maximal tolerable error that should be achieved.

When using organic photoconductive sensors of a sufficient size, the noise of the individual pixels is averaged out, as they have a Gaussian behaviour. For this purpose, the sensor can be made relatively large, for example in the range of 0.8 by 0.8 cm to 2.4 by 2.4 cm for a typical 21.3″ medical grade mammography display. At this size, the measured light for each sensor will correspond to an average of many pixels. By using only a limited number of sensors, spread over the entire area of the display, a very good approximation of the actual luminance pattern can be computed, for example, by using a matrix of 10 by 13 sensors.

While the above method has been expressed in the claims as a use of the above mentioned sensor solutions, it is to be understood that the method is also applicable to any other sensor to be used with other display types. It is more generally a method of using a matrix of sensors in combination with a display. In the preferred embodiment, the matrix of sensors is designed such that it is permanently integrated into the display's design. Therefore, a matrix of transparent organic photoconductive sensors is used preferably, suitably designed to preserve the display's visual quality to the highest possible degree.

The goal can be either to assess the luminance or color uniformity of the spatial light emission of a display, based on at least two zones.

Providing a sensing result by:

Comparing the sensor value which is actually measured in the zone to the ideally measured value which ought to be measured by the sensor for a specified display area with the applied display settings for said display area corresponding to the moment in time on which the sensor determination is based. This can either be based on a mathematical algorithm or on an additional calibration step, depending on whether a real-time measurements or offline measurements are made using uniform patches, and

Evaluating the sensing result and/or evaluating a set of sensing results for defining a display evaluation parameter;

If the display evaluation parameter is outside an accepted range, modify the display settings, or notify the user the display is out of the desired operating range, and/or continue monitoring said display area.

The average display settings as used herein are more preferably the ideally emitted luminance as discussed above.

When limiting the analysis to cross-sections of a profile and a 95% coverage of the display's active area width with sensors, results showed that for instance 7 sensors were necessary to obtain an objective global absolute relative error less than 1%, when performing tests on a typical 5 MP medical grade display when displaying an image with a constant driving level (typical result for higher driving levels, at the very lowest driving level, a slightly larger error is obtained) for the entire active area of the display, when sensors are used that have a width in the range of 50-150 display pixels. This is by using a uniform grid and a pchip interpolation method, based on an analysis for several horizontal cross-sections. The main non-uniformities lie in the border of the display and configurations of the sensors were developed using special attention to these borders. By increasing the width of the screen where the correction is applied to 99% of the display width, using two smaller sensors in each border (for instance with a size width of 20 display pixels) and a uniform grid in the central part, a total number of 10 sensors were preferably applied in order to obtain a global relative error threshold under 1% for a typical 5 MP display, when using sensors that cover have a width in the range of 50-150 pixels and pchirp interpolation, based on an analysis of several horizontal cross-sections. This increased the number of sensors, but the borders were captured to a larger extent, by suitably using the smaller sensors.

On the other hand, when analysing the two-dimensional case, it was found that using a uniform grid over 95% of the display (the same display is used as for the 1D cross-section) and a very good method based on the biharmonic spline interpolation method, for example Matlab 4 griddate method, a global error less than 1% was obtained by using a matrix of 6 by 6 or 7 by 5 sensors, at the brighter levels, with sensor sizes in the range of 50 by 50 to 150 by 150 display pixels. Furthermore, preferably using a non-uniform grid significantly reduces the error in the borders and hereby the global error. The two gridding methods were compared and showed that the non-uniform grid performs better than a uniform grid, except for the darkest very darkest levels, where the non-uniform grid performed slightly worse. Using a non-uniform grid of 6 by 5 sensors, which corresponds to a total of 30 sensors, is sufficient to have a global relative absolute error inferior to 1%, again for all but the very darkest levels, which have a slightly larger error. The maximal local errors depend significantly on the number of sensors used in the design. The number of sensors that needs to be chosen depends on the error tolerance.

In the results described here above for a cross-section and for the entire active area are based on the assumption that the matrix of sensors operate as luminance sensors, which measure light emitted by the display in perpendicular direction. Tests were also done in the case where the sensor is not an ideal luminance sensor, and has an equal response independent of the angle at which the ray impinges. It is clear for the reader skilled in the art that the distance between position at which the light is emitted and the position at which the light is captured now has an impact on the measurement. Tests were for instance done at a specific embodiment with a separation of 3 mm between the sensor and the pixels. Very good results were also obtained when using such a sensor.

On top of that, the obtained percentual errors are obtained when comparing the interpolated/approximated curves to the measured spatial luminance output data using a high-resolution camera able to measure spatial luminance output of the display as emitted perpendicularly to the display's active area, where the latter is filtered such that only the high-frequency Gaussian signal, as this solution is intended to compensate only the global, low frequency trend of the spatial non-uniformity, and therefore it does not make sense to include the minor high frequency modulation into this analysis. It is clear for anyone skilled in the art that the error between the (filtered version of) the measured spatial luminance data and the interpolated/approximated curve is sufficient as a metric, as the interpolated/approximated curve will eventually be the one used for applying the luminance uniformity correction on.

Also, it is assumed that ambient light is eliminated from the measured value as described earlier.

These and other aspects of the invention will be apparent from and elucidated with reference to the embodiments described hereinafter.

### BRIEF DESCRIPTION OF THE DRAWINGS

FIG. 1 is a schematic illustration of a display device with a sensor system according to a first embodiment of the invention;

FIG. 2 shows the coupling device of the sensor system illustrated in FIG. 1;

FIG. 3 shows a vertical sectional of a sensor system for use in the display device according to a third embodiment of the invention;

FIG. 4 shows a horizontal sectional view of a display device with a sensor system according to a fourth embodiment of the invention; and

FIG. 5 shows a side view of a display device with a sensor system according to a second embodiment of the invention;

FIG. 6a shows the first stage of amplification used for a display device with a sensor system; and

FIG. 6b shows the second stage of amplification used for a display device with a sensor system; and

FIG. 6c shows the first stage of amplification used for a display device with a sensor system; and

FIG. 7 illustrates the overview of the data path from the sensor to the processor;

FIG. 8 shows a schematic view of a network of sensors with a single layer of electrodes used in the display device;

FIG. 9a shows a measurement graph where a cross-section of a profile is measured using a relatively uniform display;

FIG. 9b shows a measurement graph comprising the positions of the measured sensors; and

FIG. 9c shows a measurement graph using the algorithm as disclosed EP1424672.

FIG. 10 illustrates a rescale process for a cross-section according to embodiments of the present invention.

FIG. 11a shows a local map of the error for profile 6 (DDL 496) in the embodiment where the sensors are located on a 6 by 6 uniform grid

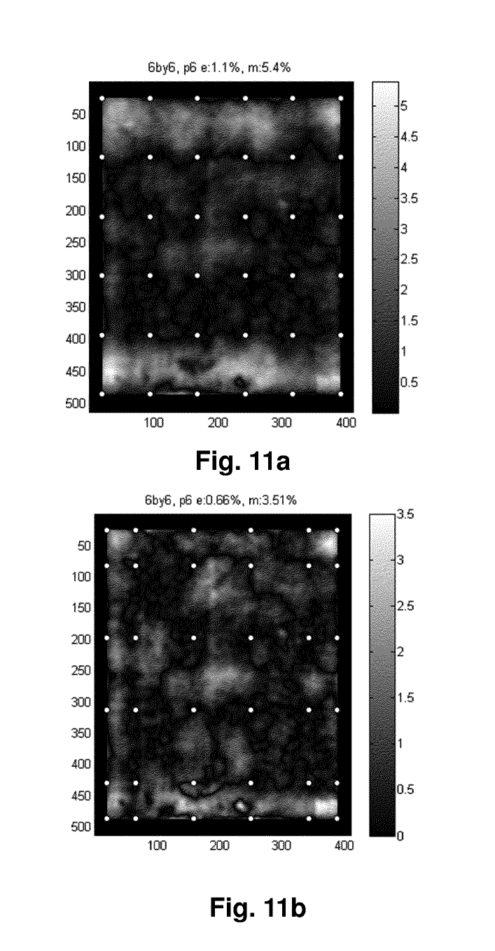

In FIG. 11b an error is depicted, for a grid used which is non-uniform on the borders of the interpolated area.

### DESCRIPTION OF THE ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. Thus, the scope of the expression “a device comprising means A and B” should not be limited to devices consisting only of components A and B. It means that with respect to the present invention, the only relevant components of the device are A and B.

Similarly, it is to be noticed that the term “coupled”, also used in the claims, should not be interpreted as being restricted to direct connections only. Thus, the scope of the expression “a device A coupled to a device B” should not be limited to devices or systems wherein an output of device A is directly connected to an input of device B. It means that there exists a path between an output of A and an input of B which may be a path including other devices or means.

It is furthermore observed that the term “at least partially transparent” as used throughout the present application refers to an object that may be partially transparent for all wavelengths, fully transparent for all wavelengths, fully transparent for a range of wavelengths and partially transparent for the rest of the wavelengths. Typically, it refers to optical transparency, e.g. transparency for visible light. Partially transparent is herein understood as the property that the intensity of an image shown through the partially transparent member is reduced due to the said partially transparent member, or its color is altered. Partially transparent refers particularly to a reduction of impinging light intensity of at most 40% at every wavelength of the visible spectrum, more preferably at most 25%, more preferably at most 10%, or even at most 5%. Typically the sensor design is created so as to be substantially transparent, i.e. with a reduction of impinging light intensity of at most 20% for every visible wavelength.

The term ‘light guide’ is used herein for reference to any structure that may guide light in a predefined direction. One preferred embodiment hereof is a waveguide, e.g. a light guide with a structure optimized for guiding light. Typically, such a structure is provided with surfaces that adequately reflect the light without substantial diffraction and/or scattering. Such surfaces may include angles of substantially 90 to 180 degrees with respect to each other. Another embodiment is for instance an optical fiber. Moreover, the term ‘display’ is used herein for reference to the functional display. In case of a liquid crystal display, as an example, this is the layer stack provided with active matrix or passive matrix addressing. The functional display is subdivided in display areas. An image may be displayed in one or more of the display areas. The term ‘display device’ is used herein to refer to the complete apparatus, including sensors, light guide members and incoupling members. Suitably, the display device further comprises a controller, driving system and any other electronic circuitry needed for appropriate operation of the display device.

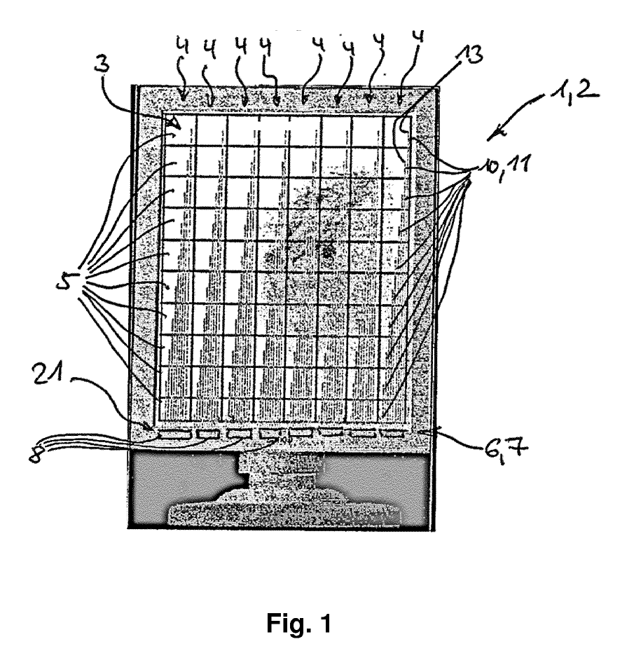

FIG. 1 shows a display device 1 formed as a liquid crystal display device (LCD device) 2. Alternatively the display device is formed as a plasma display devices or any other kind of display device emitting light. The display's active area 3 of the display device 1 is divided into a number of groups 4 of display areas 5, wherein each display area 5 comprises a plurality of pixels. The display device 3 of this example comprises eight groups 4 of display areas 5; each group 4 comprises in this example ten display areas 5. Each of the display areas 5 is adapted for emitting light into a viewing angle of the display device to display an image to a viewer in front of the display device 1.

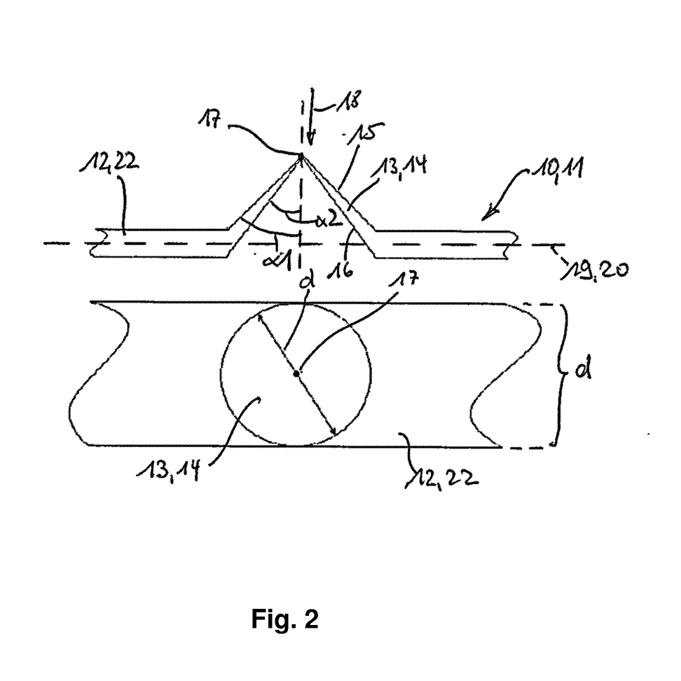

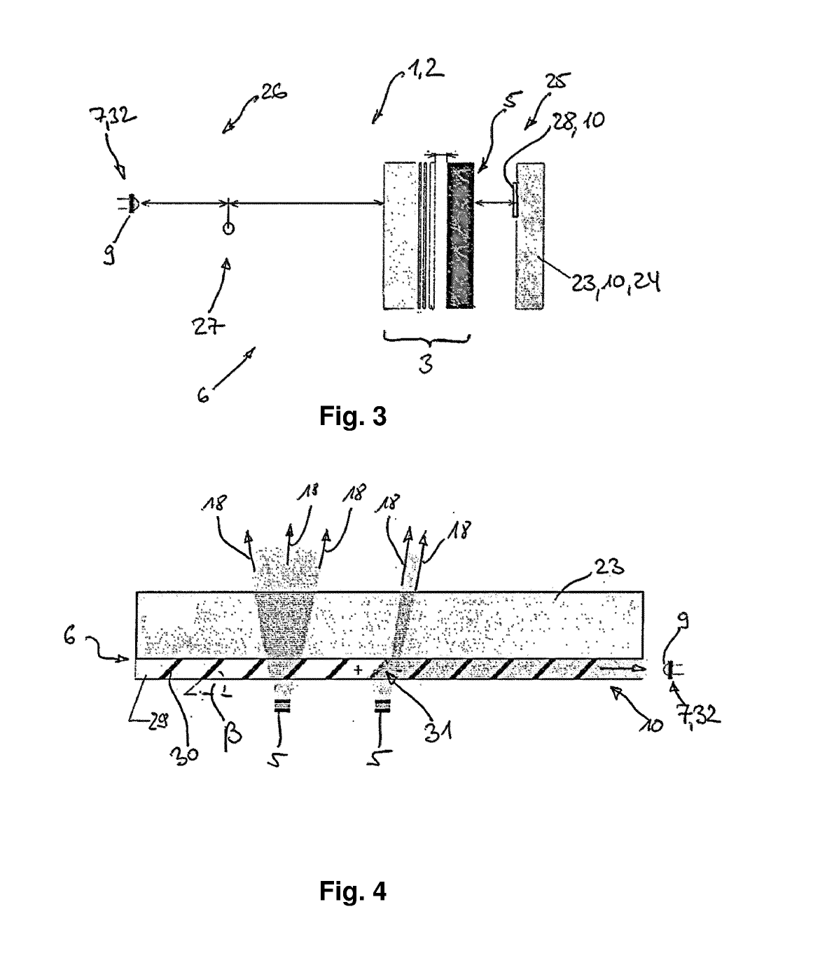

FIG. 1 further shows a sensor system 6 with a sensor array 7 comprising, e.g. eight groups 8 of sensors, which corresponds to the embodiment where the actual sensing is made outside the visual are of the display, and hence the light needs to be guided towards the edge of the display. This embodiment thus corresponds to a waveguide solution and not to the preferred organic photoconductive sensor embodiment, where the light is captured on top of (part of) the display area 5, and the generated electronic signal is guided towards the edge. In addition, in the preferred embodiment which uses organic photoconductive sensors to detect light, the actual sensor is created directly in front of the (part of) the sub area that needs to be sensed, and the consequentially generated electronic signal is guided towards the edge of the display, using semitransparent conductors. Each of said groups 8 comprises, e.g. ten sensors (individual sensors 9 are shown in FIGS. 3, 4 and 5) and corresponds to one of the groups 4 of display areas 5. Each of the sensors 9 corresponds to one corresponding display area 5. In a specific embodiment the sensor system 6 further comprises coupling devices 10 for a display area 5 with the corresponding sensors 9. Each coupling device 10 comprises a light guide member 12 and an incoupling member 13 for coupling the light into the light guide member 12, as shown in FIG. 2. A specific incoupling member is depicted in 13 shown in FIG. 2, which is cone-shaped, with a tip and a ground plane. It is to be understood that the tip of the incoupling member 13 is facing the display area 5. Light emitted from the display area 5 and arriving at the incoupling member 13, is then refracted at the surface of the incoupling member 13. The incoupling member 13 is formed, in one embodiment, as a laterally prominent incoupling member 14, which is delimited by two laterally coaxially aligned cones 15, 16, said cones 15, 16 having a mutual apex 17 and different apex angles α1, α2. The diameter d of the cones 15, 16 delimiting the incoupling member 13 can for instance be equal or almost equal to the width of the light guide member 12. Said light was originally emitted (arrow 18) from the display area 5 into the viewing angle of the display device 1, note that only light emitted in perpendicular direction is depicted, while a display typically emits in a broader opening angle. The direction of this originally emitted light is perpendicular to the alignment of a longitudinal axis 19 of the light guide member 12. All light guide members 12 run parallel in a common plane 20 to the sensor array 7 at one edge 21 of the display device 1. Said edge 21 and the sensor array 7 are outside the viewing angle of the display device 1.

Alternatively, use may be made of a diffraction grating as an incoupling member 13. Herein, the grating is provided with a spacing, also known as the distance between the laterally prominent parts. The spacing is in the order of the wavelength of the coupled light, particularly between 500 nm and 2 μm. In a further embodiment, a phosphor is used. The size of the phosphor could be smaller than the wavelength of the light to detect.

The light guide members 12 alternatively can be connected to one single sensor 9. All individual display areas 5 can be detected by a time sequential detection mode, e.g. by sequentially displaying a patch to be measured on the display areas 5.

The light guide members 12 are for instance formed as transparent or almost transparent optical fibres 22 (or microscopic light conductors) absorbing just a small part of the light emitted by the specific display areas 5 of the display device 1. The optical fibres 22 should be so small that a viewer does not notice them but large enough to carry a measurable amount of light. The light reduction due to the light guide members and the incoupling structures for instance is about 5% for any display area 5. More generally, optical waveguides may be applied instead of optical fibres, as discussed hereinafter.

Most of the display devices 1 are constructed with a front transparent plate such as a glass plate 23 serving as a transparent medium 24 in a front section 25 of the display device 1. Other display devices 1 can be made rugged with other transparent media 24 in the front section 25. Suitably, the light guide member 12 is formed as a layer onto a transparent substrate such as glass. A material suitable for forming the light guide member 12 is for instance PMMA (polymethylmethacrylate). Another suitable material is for instance commercially available from Rohm & Haas under the tradename Lightlink™, with product numbers XP-5202A Waveguide Clad and XP-6701A Waveguide Core. Suitably, a waveguide has a thickness in the order of 2-10 micrometer and a width in the order of micrometers to millimeters, or even centimeters. Typically, the waveguide comprises a core layer that is defined between one or more cladding layers. The core layer is for instance sandwiched between a first and a second cladding layer. The core layer is effectively carrying the light to the sensors. The interfaces between the core layer and the cladding layers define surfaces of the waveguide at which reflection takes place so as to guide the light in the desired direction. The incoupling member 13 is suitably defined so as to redirect light into the core layer of the waveguide.

Alternatively, parallel coupling devices 10 formed as fibres 22 with a higher refractive index are buried into the medium 24, especially the front glass plate 23. Above each area 5 the coupling device 10 is constructed on a predefined guide member 12 so light from that area 5 can be transported to the edge 21 of the display device. At the edge 21 the sensor array 7 captures light of each display area 5 on the display device 1. This array 7 would of course require the same pitch as the fibres 22 in the plane 20 if the fibres run straight to the edge, without being tightened or bent. While fibres are mentioned herein as an example, another light guide member such as a waveguide, could be applied alternatively.

In FIG. 1 the coupling devices 10 are displayed with different lengths. In reality, full length coupling devices 10 may be present. The incoupling member 13 is therein present at the destination area 5 for coupling in the light (originally emitted from the corresponding display area 5 into the viewing angle of the display device 1) into the light guide member 12 of the coupling device 10. The light is afterwards coupled from an end section of the light guide member 12 into the corresponding sensor 9 of the sensor array at the edge 21 of the display device 1. The sensors 9 preferably only measure light coming from the coupling devices 10. In addition, the difference between a property of light in the coupling device 10 and that in the surrounding front glass plate 23 is measured. This combination of measuring methods leads to the highest accuracy. The property can be intensity or colour for example.

In one method, each coupling device 10 carries light that is representative for light coming out of a pre-determined area 5 of the display device 1. Setting the display 3 full white or using a white dot jumping from one area to another area 5 gives exact measurements of the light output in each area 5.

However, by this method it is not possible to perform continuous measurements without the viewer noticing it. In this case the relevant output light property, e.g. colour or luminance, should be calculated depending on the image information, radiation pattern of a pixel and position of a pixel with respect to the coupling device 11. Image information determines the value of the relevant property of light, e.g. how much light is coming out of a specific area 5 (for example a pixel of the display 3) or its colour.

Consider the example of optical fibers 22 shaped like a beam, i.e. with a rectangular cross-section, in the plane parallel front glass plate 23, for instance a plate 23 made of fused silica. To guide the light through the fibers 22, the light must be travelling in one of the conductive modes. For light coming from outside the fibers 22 or from outside the plate 23, it is difficult to be coupled into one of the conductive modes. To get into a conductive mode a local alteration of the fiber 22 is needed. Such local alteration may be obtained in different manners, but in this case there are more important requirements than just getting light inside the fiber 22.

For accurate measuring it is important that only light from a specific direction (directed from the corresponding display area 5 into the viewing angle of the display device) enters into the corresponding coupling device 10 (fiber 22). Hence, light from outside the display device 1 (‘noisy’ light) will not interfere with the measurement.

Additionally, it is important that upon insertion into the light guide member, f.i. fiber or waveguide, the image displayed is hardly, not substantially or not at all disturbed.

According to the invention, use is made of an incoupling member 13 for coupling light into the light guiding member. The incoupling member 13 is a structure with limited dimensions applied locally at a location corresponding to a display area. The incoupling member 13 has a surface area that is typically much smaller than that of the display area, for instance at most 1% of the display area, more preferably at most 0.1% of the display area. Suitably, the incoupling member is designed such that it leads light to a lateral direction.

Additionally, the incoupling member may be designed to be optically transparent in at least a portion of its surface area for at least a portion of light falling upon it. In this manner the portion of the image corresponding to the location of the incoupling member is still transmitted to a viewer. As a result, it will not be visible. It is observed for clarity that such partial transparency of the incoupling member is highly preferred, but not deemed essential. Such minor portion is for instance in an edge region of the display area, or in an area between a first and a second adjacent pixel. This is particularly feasible if the incoupling member is relatively small, e.g. for instance at most 0.1% of the display area.

In a further embodiment, the incoupling member is provided with a ground plane that is circular, oval or is provided with rounded edges. The ground plane of the incoupling member is typically the portion located at the side of the viewer. Hence, it is most essential for visibility. By using a ground plane without sharp edges or corners, this visibility is reduced and any scattering on such sharp edges are prevented.

A perfect separation may be difficult to achieve, but with the sensor system 6 comprising the coupling device 10 shown in FIG. 2 a very good signal-to-noise-ratio (SNR) can be achieved.

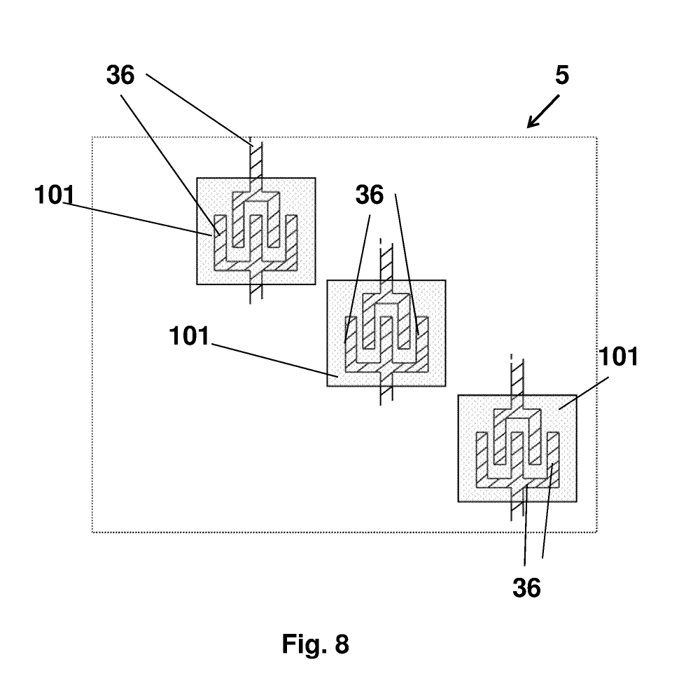

In another preferred embodiment a coupling device such as an incoupling member is not required. For example, organic photoconductive sensors can be used as the sensors. The organic photoconductive sensors serve as sensors themselves (their resistivity alters depending on the impinging light) and because of that they can be placed directly on top of the location where they should measure. (For instance, a voltage is put over its electrodes, and a impinging-light dependent current consequentially flows through the sensor, which is measured by external electronics) Light collected for a particular display area 5 does not need to be guided towards a sensor 9 at the periphery of the display (i.e. contrary to what is exemplified by FIG. 3). In a preferred embodiment, light is collected by a transparent or semi-transparent sensor 101 placed on each display area 5. The conversion of photons into charge carriers is done at the display area 5 and not at the periphery of the display and therefore the sensor, although transparent, will not be visible but will be within/inside the viewing angle. Just as for the sensor system 6 of FIG. 1, this embodiment may also have a sensor array 7 comprising, e.g. a plurality of groups, such as eight groups 8 of sensors 9, 101. Each of said groups 8 comprises a plurality of sensors, e.g. ten sensors 9 and correspond to one of the groups 4 of display areas 5. Each of the sensors 9 corresponds to one corresponding display area 5, as illustrated in FIG. 8.

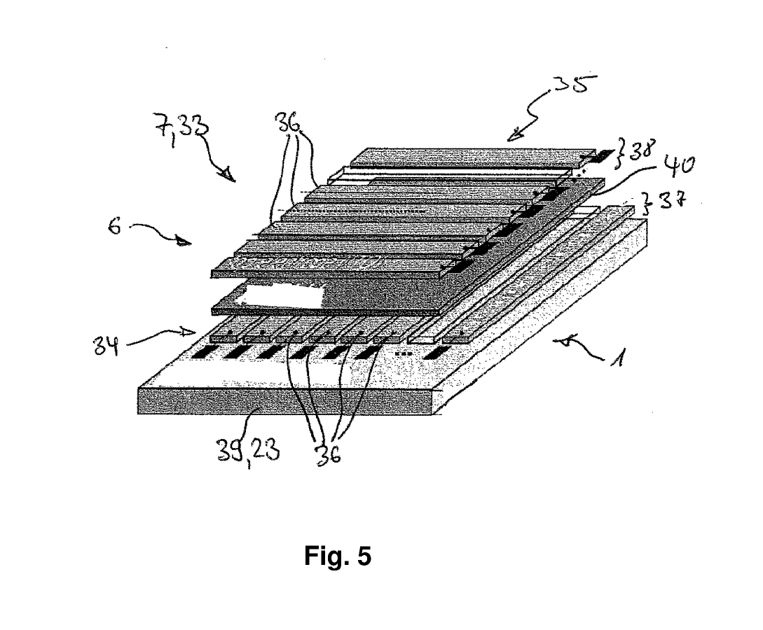

FIG. 5 shows a side view of a sensor system 9 according to a second embodiment of the invention. The sensor system of this embodiment comprises transparent sensors 33 which are arranged in a matrix with rows and columns. The sensors can for instance be, e.g. photoconductive sensors, hybrid structures, composite sensors, etc. The sensor 33 can be realized as a stack comprising two groups 34, 35 of parallel bands 36 in two different layers 37, 38 on a substrate 39, preferably the front glass plate 23. An interlayer 40 is placed between the bands 36 of the different groups 35, 36. This interlayer is the photosensitive layer of this embodiment. The bands (columns) of the first group 34 are running perpendicular to the bands (rows) of the second group 35, in a parallel plane. The sensor system 6 divides the display area 1 into different zones by design, which is clear for anyone skilled in the art, each with its own optical sensor connected by transparent electrodes.

The addressing of the sensors may be accomplished by any known array addressing method and/or devices. For example, a multiplexer (not shown) can be used to enable addressing of all sensors. In addition a microcontroller is also present (not shown). The display can be adapted, e.g. by a suitable software executed on a processing engine, to send a signal to the microcontroller (e.g. via a serial cable: RS232). This signal determines which sensor's output signal is transferred. For example, a 16 channel analogue multiplexer ADG1606 (of Analog Devices) is used, which allows connection of a maximum of 16 sensors to one drain terminal (using a 4 bit input on 4 selection pins).

The multiplexer is a preferably a low-noise multiplexer. This is important, because the signal measured is typically a low-current analogue signal, therefore very sensitive to noise. The very low (4.5Ω) on-resistance makes this multiplexer ideal for this application where low distortion is needed. This on-resistance is negligible in comparison to the resistance range of the sensor material itself (e.g. of the order of magnitude MΩ-100 GΩ). Moreover, the power consumption for this CMOS multiplexer is low.

To control the multiplexer switching, a simple microcontroller can be used (e.g. Basic Stamp 2) that can be programmed with Basic code: i.e. its input is a selection between 1 and 16; its output goes to the 4 selection pins of the multiplexer.

To communicate with the sensor, a layered software structure is foreseen. The layered structure begins from the high-level implementation in QAWeb, which can access BarcoMFD, a Barco in-house software program, which can eventually communicate with the firmware of the display, which handles the low-level communication with the sensor. In fact, by communicating with an object from upper levels, the functionality can be accessed quite easily.

The communication with the sensor is preferably a two-way communication. For example, the command to “measure” can be sent from the software layer and this will eventually be converted into a signal activating the sensor (e.g. a serial communication to the ADC to ask for a conversion), which puts the desired voltage signal over the sensor's electrodes. The sensor (selected by the multiplexer at that moment in time) will respond with a signal depending on the incoming light, which will eventually result in a signal in the high-level software layer.

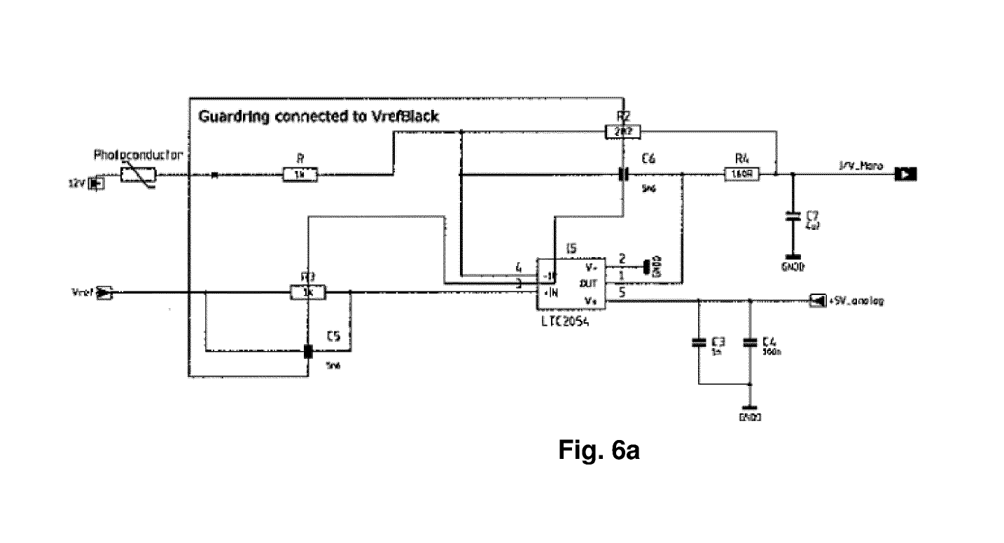

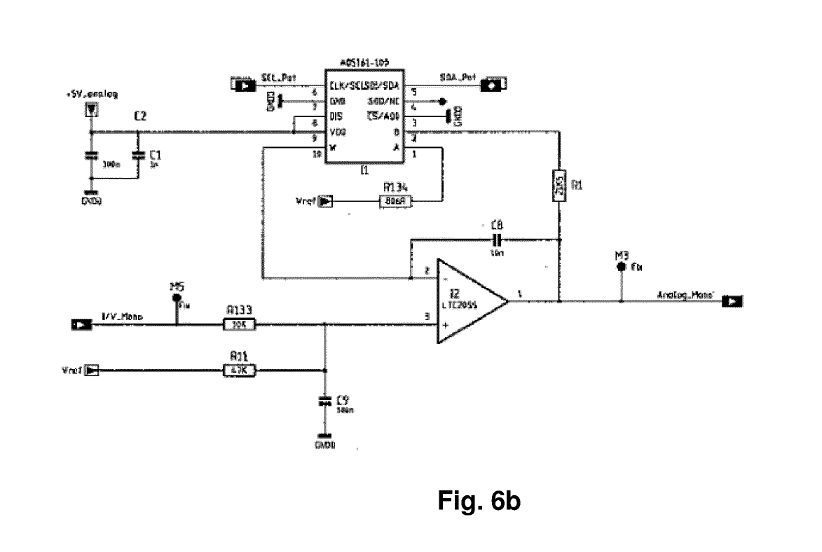

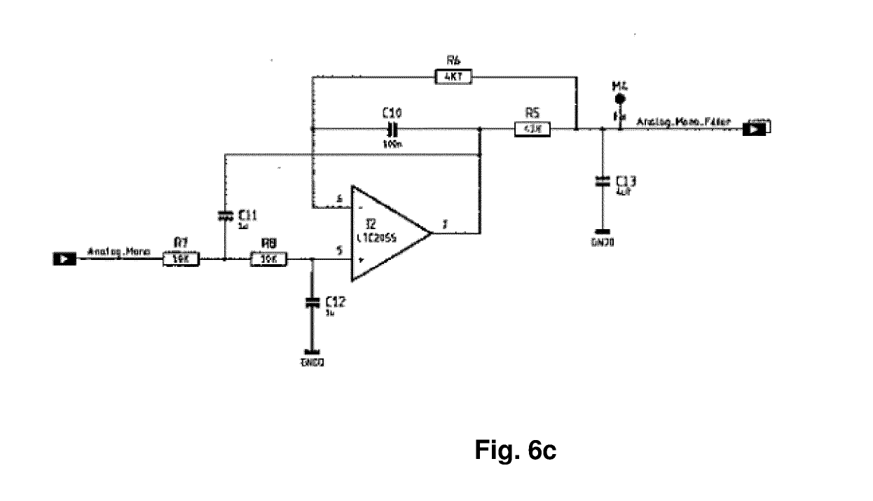

In order to reach the eventual high-level software layer, the analogue signal generated by the sensor and selected by the multiplexer is preferably filtered, and/or amplified and/or digitized. The types of amplifiers used are preferably low noise amplifiers such as LT2054 and LT2055: zero drift, low noise amplifiers. Different stages of amplification can be used. For example in an embodiment stages 1 to 3 are illustrated in FIGS. 6a to 6c respectively. In a first stage the current to voltage amplification has a first factor, e.g. with factor 2.2×10⁶Ω. In a second stage closed loop amplification is adjustable by a second factor, e.g. between about 1 and 140 (using a digital potentiometer). And finally in a third stage low band pass filtering is enabled (first order, with f0 at about 50 Hz (cfr RC constant of 22 ms)).

Digitization can be by an analog to digital, converter (ADC) such as an LTC 2420—a 20 bit ADC which allows to differentiate more than 10⁶ levels between a minimum and maximum value. For a typical maximum of 1000 Cd/m² (white display, backlight driven at high current), it is possible to discriminate 0.001 Cd/m² if no noise is present.

In addition the current timing in the circuit is mainly determined by setting of a ΔΣ-ADC such as LTC2420. Firstly, the most important time is the conversion time from analogue to digital (about 160 ms, internal clock is used with 50 Hz signal rejection). Secondly, the output time of the 24 clock cycles needs to read the 20 bit digital raw value out of the serial register of LTC2420 which is of secondary importance (e.g. over a serial 3-wire interface). The choice of the ADC (and its setting) corresponds to the target of stable high resolution light signals (20 bit digital value, averaged over a time of 160 ms, using 50 Hz filtering).

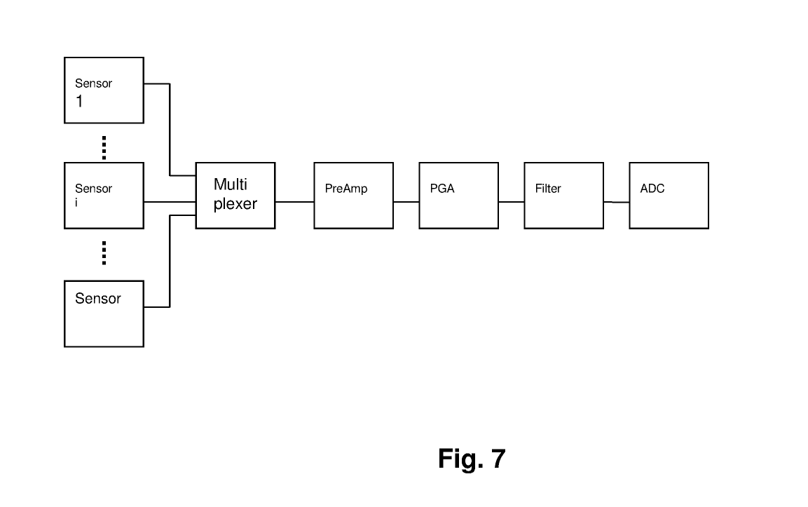

Additionally FIG. 7 illustrates the overview of data path from the sensor to the ADC. The ADC output can be provided to a processor, e.g. in a separate controller or in the display.

The embodiments that utilize a transparent sensor positioned on top of the location where they should measure, require suitable transparent electrodes, that allow the electronic signal to be guided towards the edge, where it can be analyzed by the external electronics. Suitable materials for the transparent electrodes are for instance ITO (Indium Tin Oxide) or poly-3,4-ethylenedioxythiophene polystyrene acid (known in the art are PEDOT-PSS). This sensor array 7 can be attached to the front glass or laminated on the front glass plate 23 of the display device 2, for instance an LCD.

The difference between using a structure comprising an inorganic transparent conductive material such as ITO or for instance a thin structure such as proposed in the article of J. H. Ho et al in Applied Physics Letters 93 is not only the use of an inherently transparent material such as ITO instead of an inherently non-transparent material such as gold electrodes. The work function of the electrode material influences the efficiency of the sensor. In the bilayer photoconductor created in the previously mentioned article, a material with a higher work function is most likely more efficient. Therefore, Au is used which has a work function of around 5.1 eV, while ITO has a work function of typically 4.3-4.7 eV, This would result in a worse performance. These known designs seem to teach away from ITO at least when one expects an efficient sensor. The article cited above uses gold as electrode, U.S. Pat. No. 6,348,290 suggests the use of a number of metals including Indium or an alloy of Indium (see also column 7 lines 25-35 of US'290). Conductive Tin Oxide is not named. Furthermore, U.S. Pat. No. 6,348,290 suggests using an alloy because of its superiority in e.g. electrical properties. However, when ITO is used in stead of gold, it was an unexpected finding that the structure would work so well as to be usable for the monitoring of luminance in a display. Also, previous known designs did not aim to create a transparent sensor, since gold or other metal electrodes are used, which are highly light absorbing. In accordance with embodiments of the present invention, use is made of an at least partially transparent electrode material. This is for instance ITO.

Returning to FIG. 8, the organic layer(s) 101 is preferably an organic photoconductive layer, and may be a monolayer, a bilayer, or a multiple layer structure. Most suitably, the organic layer(s) 101 comprises an exciton generation layer (EGL) and a charge transport layer (CTL). The charge transport layer (CTL) is in contact with a first and a second transparent electrode, between which electrodes a voltage difference may be applied. The thickness of the CTL can be for instance in the range of 25 to 100 nm, f.i. 80 nm. The EGL layer may have a thickness in the order of 5 to 50 nm, for instance 10 nm. The material for the EGL is for instance a perylene derivative. One specific example is 3,4,9,10-perylenetetracarboxylic bisbenzimidazole (PTCBI). The material for the CTL is typically a highly transparent p-type organic semiconductor material. Various examples are known in the art of organic transistors and hole transport materials for use in organic light emitting diodes. Examples include pentacene, poly-3-hexylthiophene (P3HT), 2-methoxy, 5-(2′-ethyl-hexyloxy)-1,4-phenylene vinylene (MEH-PPV), N,N′-bis(3-methylphenyl)-N,N′-diphenyl-1,1′-biphenyl-4,4′-diamine (TPD). Mixtures of small molecules and polymeric semiconductors in different blends could be used alternatively. The materials for the CTL and the EGL are preferably chosen such that the energy levels of the orbitals (HOMO, LUMO) are appropriately matched, so that excitons dissociate at the interface of both layers. In addition to these two layers, a charge separation layer (CSL) may be present between the CTL and the EGL in one embodiment. Various materials may be used as charge separation layer, for instance AlO3.

Instead of using a bilayer structure, a monolayer structure can also be used. This configuration is also tested in the referenced paper, with only an EGL. Again, in the paper, the electrodes are Au, whereas we made an embodiment with ITO electrodes, such that a (semi) transparent sensor can be created. Also, we created embodiments with other organic layers, both for the EGL as well as the CTL, such as PTCDA, with ITO electrodes. In a preferred embodiment, we used PTCBi as EGL and TMPB as CTL. The organic photoconductive sensor may be a patterned layer or may be a single sheet covering the entire display. In the latter case, each of the display area 5 will have its own set of electrodes but they will share a common organic photosensitive layer (simple or multiple). The added advantage of a single sheet covering the entire display is that the possible color specific absorption by the organic layer will be uniform across the display. In the case where several islands of organic material are separated on the display, non-uniformity in luminance and or color is more difficult to compensate.

In one further implementation, the electrodes are provided with fingered shaped extensions, as presented in FIG. 8 as well. The extensions of the first and second electrode preferably form an interdigitated pattern. The number of fingers may be anything between 2 and 5000, more preferably between 100 and 2500, suitably between 250 and 1000. The surface area of a single transparent sensor may be in the order of square micrometers but is preferable in the order of square millimeters, for instance between 1 and 7000 square millimeters. One suitable finger shape is for instance a 1500 by 80 micrometers size, but a size of for instance 4×6 micrometers is not excluded either. The gap in between the fingers can for instance be 15 micrometers in one suitable implementation.

In connection with said further implementation, it is most suitable to build up the sensor on a substrate with said electrodes. The organic layer 101 therein overlies or underlies said electrodes. In other words,

In FIG. 8, a network of sensors 9 with a single layer of electrodes 36 is illustrated. Electrodes 36 are made of a transparent conducting material like any of the materials described above e.g. ITO (Indium Tin Oxide) and are covered by the organic layer(s) 101. In addition, the organic photoconductive sensor does not need to be limited laterally. The organic layer may be a single sheet covering the entire display (not shown). Each of the display areas 5 will have its own set of electrodes 36 (one of the electrodes can be shared in some embodiments where sensors are addressed sequentially) but they can share a common organic photosensitive layer (simple or multiple). The added advantage of a single sheet covering the entire display is that the possible color specific absorption by the organic layer will be to a major extent uniform across the display. In the case where several islands of organic material are separated on the display, non-uniformity in luminance and or color is more difficult to compensate.

The first and second electrode may, on a higher level, be arranged in a matrix (i.e. the areas where the finger patterns are located are arranged over the display's active area according to a matrix) for appropriate addressing and read out, as known to the skilled person. Most suitably, the organic layer(s) is/are deposited after provision of the electrodes. The substrate may be provided with a planarization layer.

Optionally, a transistor may be provided at the output of the photosensor, particularly for amplification of the signal for transmission over the conductors to a controller. Most suitably, use is made of an organic transistor. Electrodes may be defined in the same electrode material as those of the photodetector.

The organic layer(s) 101 may be patterned to be limited to one display area 5, a group of display areas 5, or alternatively certain pixels within the display area 5. Alternatively, the interlayer is substantially unpatterned. Any color specific absorption by the transparent sensor will then be uniform across the display.

Alternatively, the organic layer(s), as illustrated in FIG. 8, may comprise nanoparticles or microparticles, either organic or inorganic and dissolved or dispersed in an organic layer. Further alternatives are organic layer(s) 101 comprising a combination of different organic materials. As the organic photosensitive particles often exhibit a strongly wavelength dependent sensitive absorption coefficient, such a configuration can result in a less colored transmission spectrum. It may further be used to improve detection over the whole visible spectrum, or to improve the detection of a specific wavelength range

Suitably, more than one transparent sensor may be present in a display area 5, as illustrated in FIG. 8. Additional sensors may be used for improvement of the measurement, but also to provide different colour-specific measurements. Additionally, by covering substantially the full front surface with transparent sensors, any reduction in intensity of the emitted light due to absorption and/or reflection in the at least partially transparent sensor will be less visible or even invisible, because position-dependant variations over the active area can be avoided this way.

Returning to FIG. 5, we note that by constructing the sensor 9 as shown in FIG. 5, the sensor surface of the transparent sensor 30 is automatically divided in different zones. A specific zone corresponds to a specific display area 5, preferably a zone consisting of a plurality of pixels, and can be addressed by placing the electric field across its columns and rows. The current that flows in the circuit at that given time is representative for the photonic current going through that zone.

This sensor system 6 cannot distinguish the direction of the light. Therefore the photocurrent going through the transparent sensor 30 can be either a pixel of the display area 5 or external (ambient) light. Therefore reference measurements with an inactive backlight device are suitably performed. Suitably, the transparent sensor is present in a front section between the front glass and the display. The front glass provides protection from external humidity (e.g. water spilled on front glass, the use of cleaning materials, etc.). Also, it provides protection form potential external damaging of the sensor. In order to minimize negative impact of any humidity present in said cavity between the front glass and the display, encapsulation of the sensor is preferred.

FIG. 4 shows a horizontal sectional view of a display device 1 with a sensor system 6 according to a fourth embodiment of the invention. The present embodiment is a scanning sensor system. The sensor system 6 is realized as a solid state scanning sensor system localized the front section of the display device 1. The display device 1 is in this example an liquid crystal display, but that is not essential. This embodiment provides effectively an incoupling member. The substrate or structures created therein (waveguide, fibers) may be used as light guide members.

In accordance with this embodiment of the invention, the solid state scanning sensor system is a switchable mirror. Therewith, light may be redirected into a direction towards a sensor. The solid state scanning system in this manner integrates both the incoupling member and the light guide member. In one suitable embodiment, the solid state scanning sensor system is based on a perovskite crystalline or polycrystalline material, and particularly the electro-optical materials Typical examples of such materials include lead zirconate titanate (PZT), lanthane doped lead zirconate titanate (PLZT), lead titanate (PT), bariumtitanate (BaTiO3), bariumstrontiumtitantate (BaSrTiO3). Such materials may be further doped with rare earth materials and may be provided by chemical vapour deposition, by sol-gel technology and as particles to be sintered. Many variations hereof are known from the fields of capacitors, actuators and microactuators (MEMS).

In one example, use was made of PLZT. An additional layer 29 can be added to the front glass plate 23 and may be an optical device 10 of the sensor system 6. This layer is a conductive transparent layer such as a tin oxide, e.g. preferably an ITO layer 29 (ITO: Indium Tin Oxide) that is divided in line electrodes by at least one transparent isolating layer 30. The isolating layer 30 is only a few microns (μm) thick and placed under an angle β. The isolating layer 30 is any suitable transparent insulating layer of which a PLZT layer (PLZT: lanthanum-doped lead zirconate titanate) is one example. The insulating layer preferably has a similar refractive index to that of the conductive layer or at least an area of the conductive layer surrounding the insulating layer, e.g. 5% or less difference in refractive index. However; when using ITO and PLZT, this difference can be larger; a PLZT layer can have a refractive index of 2,48, whereas ITO has a refractive index of 1,7 The isolating layer 31 is an electro-optical switchable mirror 31 for deflecting at least one part of the light emitted from the display area 5 to the corresponding sensor 9 and is driven by a voltage. The insulating layer can be an assembly of at least one ITO sub-layer and at least one glass or IPMRA sub-layer.

In one further example, a four layered structure was manufactured. Starting from a substrate, f.i. a corning glass substrate, a first transparent electrode layer was provided. This was for instance ITO in a thickness of 30 nm. Thereon, a PZT layer was grown, in this example by CVD technology. The layer thickness was approximately 1 micrometer. The deposition of the perovskite layer may be optimized with nucleation layers as well as the deposition of several subsequent layers, that do not need to have the same composition. A further electrode layer was provided on top of the PZT layer, for instance in a thickness of 100 nm. In one suitable example, this electrode layer was patterned in fingered shapes. More than one electrode may be defined in this electrode layer. Subsequently, a polymer was deposited. The polymer was added to mask the ITO finger pattern. When to this structure a voltage is applied between the bottom electrode and the fingers on top of the PZT the refractive index of the PZT under each of the fingers will change. This change in refractive index will result in the appearance of a diffraction pattern. The finger pattern of the top electrode is preferably chosen so that a diffraction pattern with the same period would diffract light into direction that would undergo total internal reflection at the next interface of the glass with air. The light is thereafter guided into the glass, which directs the light to the sensors positioned at the edge. Therewith, all it is achieved those diffraction orders higher than zero are coupled into the glass and remain in the glass. Optionally, specific light guiding structures, e.g. waveguides may be applied in or directly on the substrate.

While it will be appreciated that the use of ITO is here highly advantageous, it is observed that this embodiment of the invention is not limited to the use of ITO electrodes. Other partially transparent materials may be used as well. Furthermore, it is not excluded that an alternative electrode pattern is designed with which the perovskite layer may be switched so as to enable diffraction into the substrate or another light guide member.

The solid state scanning sensor system has no moving parts and is advantageous when it comes to durability. Another benefit is that the solid state scanning sensor system can be made quite thin and doesn't create dust when functioning.

An alternative solution can be the use a reflecting surface or mirror 28 that scans (passes over) the display 3, thereby reflecting light in the direction of the sensor array 7. Other optical devices may be used that are able to deflect, reflect, bend, scatter, or diffract the light towards the sensor or sensors.

The sensor array 7 can be a photodiode array 32 without or with filters to measure intensity or colour of the light. Capturing and optionally storing measured light in function of the mirror position results in accurate light property map, e.g. colour or luminance map of the output emitted by the display 3. A comparable result can be achieved by passing the detector array 9 itself over the different display areas 5.

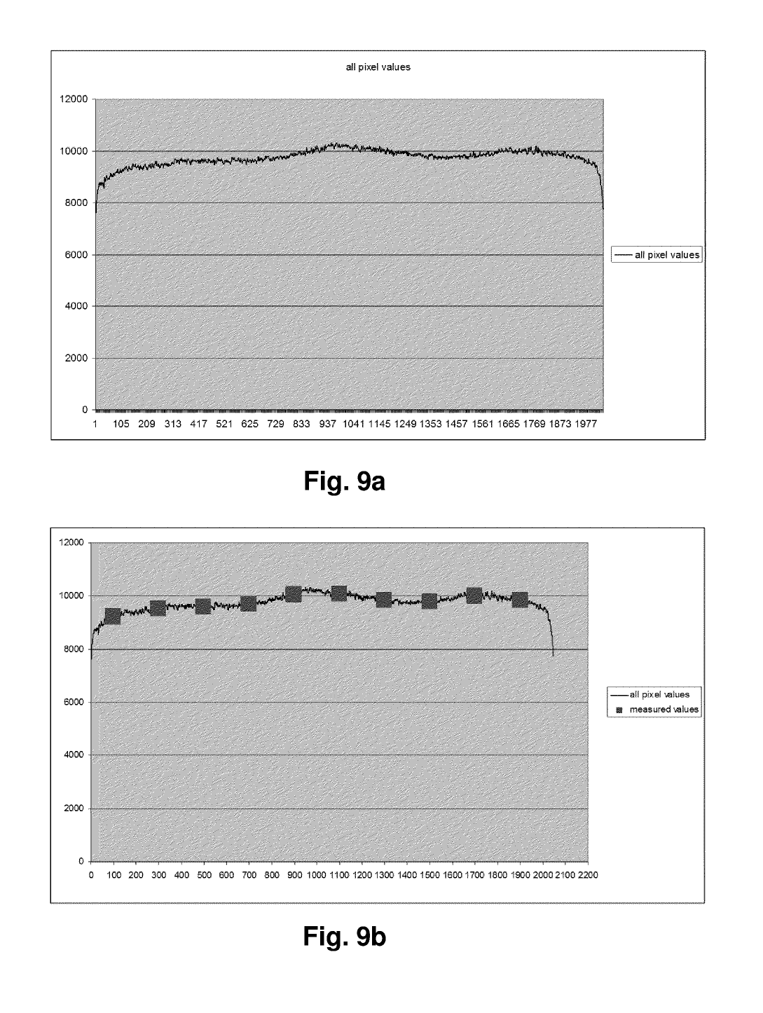

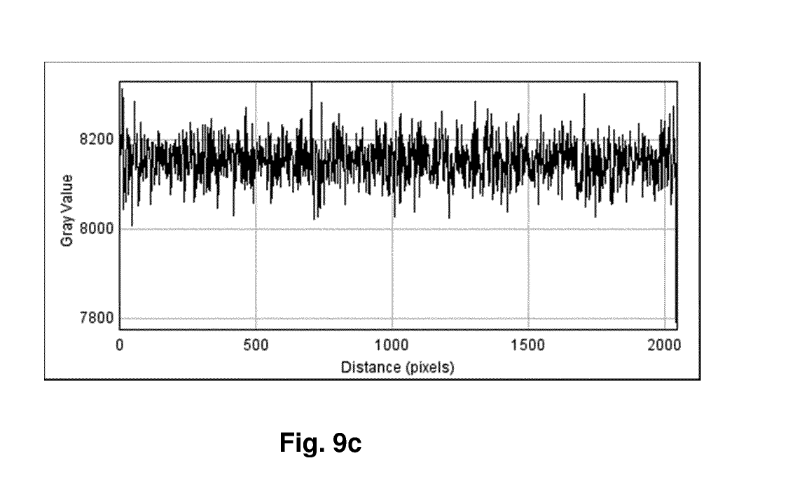

Some results obtained from luminance measurement using embodiments of the device described in this invention are illustrated FIGS. 9a, 9b and 9c. Note that the luminance measurements described here are perpendicular to the display's active area. The measurements can typically be used to characterize the non-uniformity of the luminance (or color in an alternative embodiment) of a display, or it can alternatively be used as input for an algorithm to remove the low-frequency, global, spatial luminance trend. As pointed out earlier when using the embodiment with only a limited amount of sensors, the global trend can be interpolated or approximated. The Gaussian high-frequency noise is averaged out by designing the sensors with a suitable size and the measured points are a measure of the global trend only. As the resulting data only contains a limited set of data points (e.g. a matrix of 10 by 13 data points), a suitable interpolation algorithm needs to be implemented in order to derive the missing data between the measured points. The obtained interpolated or approximated curve can then be used as input in a spatial luminance correction algorithm to eventually obtain a uniform spatial luminance output.

In the FIG. 9a, a cross-section of a profile measured using a high-resolution camera (suitably calibrated such that it measures luminance in perpendicular direction as emitted by the display) on a relatively uniform display is presented. In FIG. 9b, the positions of the measured sensors according to this invention are indicated using squares on top of the measurement using the high-resolution camera. The width of a square corresponds to the size of a 1 cm sensor. It is clear from FIG. 9b for anyone skilled in the art that a good interpolation or approximation can be suitably applied using this limited number of measurement points (for instance by using the pchirp interpolation) with sensors according to this invention, to obtain a good approximation of the camera measurement. At the corners complex effects, such as mach banding for instance can occur therefore a more uniform luminance profile is perceived. On top of that, creating the sensors with a very tiny width has no use as the high-frequency trend will no longer be filtered out, which is undesired. Therefore, the analysis is typically limited to a certain percentage of the display area, excluding the very edge of the display borders.

A horizontal section has been used in the example described. In vertical direction, more sensors will have to be used since this type of displays is typically used in portrait mode. A 5 MP display typically has a resolution of 2048 (horizontally) by 2560 pixels (vertically), in other words an aspect ratio of 4:5. Therefore, 13 sensors in vertical direction can be used, leading to a matrix of 10 by 13 sensors. This number is an example. In addition, the sensors can also be used for other display types which exhibit other noise patterns.

The matrix of sensors could also be used to redo some uniformity correction algorithms which are typically done initially in production of a display unit. When this correction is applied, a cross-section of the emitted light is taken, like illustrated in FIG. 9c. In this figure, only the high-frequency noise remains, and the global, low frequency spatial noise trend has been successfully eliminated by suitably applying a uniformity correction algorithm.

In the present invention, several models can be applied, which can be classified in two groups. The first uses a straight forward positioning of the sensors, namely by using a uniform grid, with a constant sensor size, and positioned uniformly over the cross-section (or rather, the central part of the cross-section which will be corrected). The second group of models preferably uses two different rules for the positioning; the first is to use a denser concentration of sensors in the borders of the display (the number of sensors in the border is also a design parameter that can be selected), because they present the main global, low-frequency luminance non-uniformities. On top of that, their size may be designed differently from the other sensors as the borders present a steeper drop-off which corresponds to a higher spatial frequency, and consequentially the need to use smaller sensors. Moreover, a second rule is to use different interpolation techniques as this will permit to adapt the fit to cope with the typically dissimilar profiles in the center and at the borders without influencing the rest of the curve. As described earlier, the interpolation/approximation methods used are for instance the linear interpolation, the cubic interpolation, pchip interpolation, Catmull-Rom interpolation and the B-spline approximation. Typically, a different interpolation/approximation technique can be used for the central sensors and for the sensors located at the border.

It is clear from the previous paragraphs that there are various design parameters that can be optimized to obtain the most suitable solution for this problem, as explained in the summary of the invention. These design parameters are the size of the sensor, the positioning of the sensors, and the related type of grid which can be uniform, or optimized for the borders, the number of sensors, the type of interpolation/approximation technique used, the metric used to assess the quality of the interpolated/approximated curve, the percentage of the display's active area we wish to correct (always the central part will be corrected if only a limited part is corrected, the borders will remain unaltered.

When using the first model, which is more an intuitive approach, the sensors are preferably positioned uniformly over the considered part of the display's active area, for example 95%, and the cross-section of the emitted light of the display is taken. Then the average value is measured by each sensor and the aforementioned interpolation methods are run through the points. In order to assess the quality of the approximation, various metrics can be used. The measure used here is the relative absolute error globally over the entire dataset. In addition, the local relative differences over the entire dataset can be considered. The global relative absolute error is computed by normalizing the sum of absolute local differences by the sum of the data values. On top of that, the obtained percentual errors are obtained when comparing the interpolated/approximated curves to the measured spatial luminance output data using a high-resolution camera able to measure spatial luminance output of the display as emitted perpendicularly to the display's active area, where the latter is filtered such that only the high-frequency Gaussian signal, as this solution is intended to compensate only the global, low frequency trend of the spatial non-uniformity, and therefore it does not make sense to include the minor high frequency modulation into this analysis. It is clear for anyone skilled in the art that the error between the (filtered version of) the measured spatial luminance data and the interpolated/approximated curve is sufficient as a metric, as the interpolated/approximated curve will eventually be the one used for applying the luminance uniformity correction on. By running the simulations with only one design parameter changing, for instance the number of sensors, one can assess the effect of this parameter. In addition, for each combination of parameters, the interpolation/approximation methods cited above can be applied and the relative absolute error is stored and applied as an indicator of the quality of the approximation. Results showed a large drop-off when 5 to 10 sensors were used, whereas a somewhat smaller, but still steady decline was observed when more sensors were used. Because of the presence of chance when evaluating a configuration of the sensors, we will present the results for the average relative absolute error over a set of cross-sections rather than for a single one. Indeed, sometimes a larger number of sensors does not result in a lower error for every individual cross-section, as the positioning for the lower number of sensors may be accidentally well-suited on the cross-section considered, however, when taking a large set of cross-sections and averaging them, this trend disappeared. Therefore, by taking a sufficiently large number of cross-sections, we expect to observe a monotonous decrease of the global relative absolute error with the number of sensors and no increase.

Very good results have been obtained when using the following design parameters: a sensor width in the range of 50-150 display pixels, between 7 and 15 sensors (horizontal direction), depending on the desired (global or local) relative absolute error, and using the pchirp interpolation algorithm. A specific embodiment using 7 sensors was described in the summary of the invention.

In addition, according to embodiments of the present invention, a second model is developed to enable a better approximation of the borders. This will allow increasing the percentage of the width that one would want to model. The basic idea is to use smaller sensors in the borders of the screen than in the center. When implementing an embodiment, for instance seven sensors, which are spread such that on every border there are 2 sensors of width 20, interpolated using simple linear interpolation. The remaining 3 sensors of for instance width 100 are equally spaced, in addition 99% of the total width of the display will be considered, as this method is optimized for correcting a larger percentage of the display's active area. The different interpolation methods are run through five of the seven sensors; the three central large ones and the two most central small sensors (one per side). When interpolating the two small sensors preferably are included such that the interpolated/approximated signal is continuous. When using different interpolation methods, different behaviors can be observed.

Similarly as before, in order to avoid the strange behavior due to chance when considering a single cross-section, as discussed previously, the average global relative absolute error is computed for multiple cross-sections, and averaged. In this embodiment, in each border, two sensors of size 20 are positioned at a fixed distance of 150 pixels. The remaining sensors are located uniformly on the central part of the display. The results of the simulations provided that this embodiment renders very good results when using the following design parameters: a sensor width in the range of 50-150 display pixels, between 10 and 20 sensors (horizontal cross-section), depending on the desired (global or local) relative absolute error, and using the pchirp interpolation algorithm. A specific embodiment using 10 sensors was described in the summary of the invention, which allows obtaining results beyond the 1% limit in the global relative absolute error and there are only few differences in the error for sensors in this range of sensor widths. These results have been obtained at higher driving levels, a slightly larger error was obtained at the very lowest driving levels,

In a further embodiment, three sensors are positioned in each border. They are at a distance of 150 pixels from one and other and are linked using linear interpolation. The remaining sensors are located uniformly on the central part of the display and are connected using the usual interpolation methods. Note that the minimum number of sensors is six in this situation, since we require at least 3 sensors per side. Results show that using this methodology 11 sensors are required to have an global relative absolute error smaller than 1 percent. This means 3 sensors per border and 5 sensors in the center. Here, the size of the central sensors does not impact significantly the results. These results have also been obtained at higher driving levels, a slightly larger error was obtained at the very lowest driving levels.

The methodology described so far uses the points measured by the sensors and draws the approximation curve. Although increasing the number of sensors results in a better fit, it may be possible to extract additional useful data from a camera image when it is taken initially when producing the display in the manufacturing facility. The largest local error between the data and the approximation curve occurs when the curvature of the approximation is different than the data curvature. To solve this, prior knowledge of the data could be used, with this knowledge the displays are calibrated in production and a look-up table is created. If the degradation of the correction pattern remains limited over time, this could provide additional knowledge in order to determine the approximation.

For instance, when analyzing measurements performed before and after a vibration process (this vibration process can for instance be used to emulate a display under severe transportation of movement/manipulation test), two data sets for the same driving level were obtained for a screen of size 338×422 mm with 24 by 30 measurement points. The data after vibration corresponds to the input data in the situation above, meaning that the sensors would be applied on them, this is the pattern on which sensors would perform actual measurements in the field on which the interpolation methods described earlier can be performed and the data before vibration can be considered to be prior knowledge. Sensors then are placed on the screen and for instance two interpolations methods are preferably run, namely a pchip and a B-spline. As mentioned, the prior knowledge corresponds to the data before vibration, and after vibration, the distortions are larger. The prior data however cannot be used directly as new points in the interpolation. As the peaks seem to get amplified after vibration, preferably the location and the amplitude of local peaks in the prior data are used do define new points. In that case we would rather use an approximation method (not interpolating) as the extra knots would pull the curve toward them, without forcing to interpolate. This additional knowledge preferably can be used to obtain a better-fitting curve.

Unfortunately, based on the results on this vibration data set, no useful information seems to be extractable from the prior knowledge, moreover it did not provide better results. Though the local peaks or local blips seem to be amplified after vibration, this may not be true in general.

The interpolation described above, relates to the one dimensional case. While this is very interesting to get a profound insight into the problem, the actual spatial luminance output of the display is a 2D map. Therefore, in the two dimensional case, the sensors preferably define a two dimensional grid instead of a single line. As before, every sensor stores a single value, namely the average of the measured data. This defines control points and then a two-dimensional interpolation or approximation method is run through them. Again, the choice of the design parameters, analogous to the 1D case, will determine the final shape. In the first model, the values captured by the sensors are measured and plotted in 2D and the sensors are spread uniformly over the surface of the display. The values were interpolated using cubic interpolation, linear interpolation, and a method based on biharmonic spline interpolation. Similarly to the one-dimensional case, a purely objective error computation can be used, by filtering the data captured by the camera summing the absolute differences between the filtered data and the interpolated/approximated data after which they are normalized, to obtain the global relative absolute error. The filtering will be based on a rotationally symmetric Gaussian low pass filtered version of the measured luminance profile. This will cancel out the high frequencies. In addition, another objective metric consists in measuring the maximal local relative absolute error. Instead of measuring only a global error, this captures the local deviation from the data.

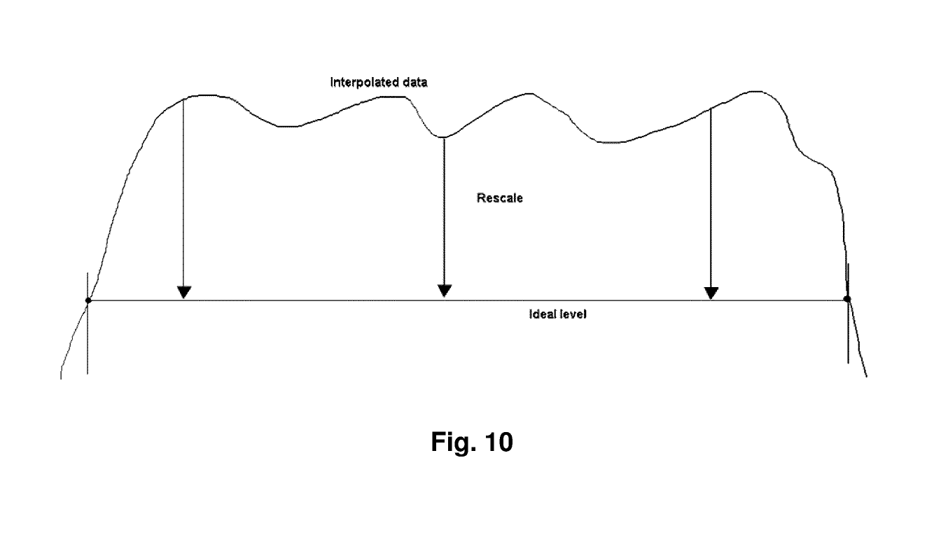

Moreover, as both shapes can be considered as images, we propose to use the SSIM metric. The structural similarity (SSIM) is a general and commonly used tool to assess the difference in quality of two images which is based on the human visual system. The first image is the uniform image we ideally want to reach. The second image is the ideal image we want to reach, with the scaled error modulated on top. The error is the difference between the actual measured signal, and the interpolated/approximated signal. The error is scaled in the same way as the scaling of the measured signal to obtain the ideal, uniform image. This scaled error is then added as a modulation on top of the ideal image. This resulting rescaled error is a consequence of the difference between the image we would obtain by using the interpolated or approximated curve instead of the actual curve for the luminance uniformity correction. Both images can be normalized, in the sense that the pattern at the highest luminance level is normalized to 255, and the other gray levels are normalized with the same factor. The normalization depends on the dynamic range of the pixel values. Moreover, as the metric captures the similarity between two images, it is not necessary to filter the data. That is, the scaled error still contains the noise and this noise is accounted for by the metric. FIG. 10 illustrates the rescale process for a cross-section. The interpolated data are rescaled to the ideal level, which is determined by the minimum interpolated data. The actual data is also rescaled with the same factor. Consequentially, the error occurs as a modulation added on top of the ideal level. The value to which the ideal level is then normalized depends on the level of brightness of the image. When considering a uniform grid over 95% of the display width, preferably four parameters are considered, namely the number of sensors in the x-direction, the number of sensors in the y-direction, the size of the sensors and the interpolation method Using a method based on the biharmonic spline interpolation method, a uniform grid of 7×5 or 6×6 sensors is sufficient to obtain a relative absolute global error less than 1%, when using square sensors of 50 by 50 pixels. These results have also been obtained at higher driving levels, a slightly larger error was obtained at the very lowest driving levels. We also saw that there is again flexibility in the sensor size, similar results have been obtained for square sensors of 50 by 50 to 150 by 150 pixels. As the maximal local relative absolute error can still be in the range of 8%, a matrix with a higher number of sensors can be beneficial of a smaller maximal local error is desired. Using the SSIM metric, the SSIM values were computed for each profile and each respective level, then their value were averaged. The SSIM metric results that we see that the images which have a very similar structure and that the similarity increases with the number of sensors. However, the values cannot easily be used in an intuitive way to actually determine the best configuration, as this would require fixing an arbitrary threshold. Based on the metrics used, the best method among the three is the interpolation method based on the biharmonic spline interpolation method. It consistently produces globally the lowest relative error, the best SSIM values and the minimal local error. These results show that the objective metrics and subjective metrics are consistent, the same conclusions were drawn for both metrics.

Similarly to the one-dimensional case, the analysis using a grid with special attention on the borders has also been performed; more specifically the dependence of different gridding in the borders has been analyzed. This is illustrated in FIG. 11a which shows a local map of the error for profile 6 (DDL 496) when the sensors are located on a 6 by 6 uniform grid. Since the data illustrated in FIG. 11a are not extrapolated to the borders of the display, but only interpolated inside the convex hull defined by the set of sensors, there is an external ring which is put at 0. The main differences between the interpolated and the true signal are located towards the borders of the interpolated area. The structure presented holds for every DDL larger than 208. For lower levels, no significant structure is present. When analyzing the two-dimensional case, a non uniform grid with smaller spacing between the sensors in the borders was chosen. In FIG. 11b the error is depicted, where the dots indicate the location of the sensors of size 50by50. Here the grid used is non-uniform on the borders of the interpolated area.

More specifically, a grid comprises spacing between the two first sensors was constructed, both in the horizontal and vertical direction, whereby the spacing is half the spacing between two other adjacent sensors. Though this configuration uses the exact same number of sensors, it offers a significant improvement of the interpolation, in all but the very lowest driving levels, at the very darkest levels; a slightly larger error was obtained when using this alternative grid.

In the results described here above for a cross-section and for the entire active area are based on the assumption that the matrix of sensors operate as luminance sensors, which measure light emitted by the display in perpendicular direction. Tests were also done in the case where the sensor is not an ideal luminance sensor, and has an equal response independent of the angle at which the ray impinges. It is clear for the reader skilled in the art that the distance between position at which the light is emitted and the position at which the light is captured now has an impact on the measurement. Tests were for instance done at a separation of 3 mm between the sensor and the pixels. Very good results were also obtained when using such a sensor. Also, it is assumed that ambient light is eliminated from the measured value as described earlier.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. In the claims the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1-20. (canceled)

21. A display device, comprising:
a plurality of display areas each provided with a plurality of pixels, each display area, comprising:
at least two partially transparent sensors for detecting a property of light emitted from at least a part of said display area into a viewing angle of the display device, the sensors being located in a front section of said display device in front of said display areas; and
a means to maintain spatial luminance and colour uniformity of the light emitted by the display during the display's lifetime by measuring a property of the emitted light at the plurality of display areas using the sensors

22. The display device as claimed in claim 21, wherein each of the sensors comprises an organic photoconductive sensor.

23. The display device according to claim 21, further comprising a controller for luminance uniformity correction of the display in accordance with the measurements of the property of the emitted light at the plurality of display areas using the sensors.

24. The display device according to claim 21, further comprising at least partially transparent electrical conductors for conducting a measurement signal from said sensors within said viewing angle for transmission to a controller.

25. The display device according to claim 21, wherein the property of the emitted light is determined pixel-by-pixel by interpolating between the measured properties of the emitted light at the plurality of display areas using the sensors.

26. The display device according to claim 25, wherein the at least partially transparent electrodes comprise an electrically conductive oxide.

27. The display device according to claim 21, wherein each sensor is a bilayer structure with an exciton generation layer and a charge transport layer, said charge transport layer being in contact with a first and a second electrode.

28. The display device according to claim 21, further comprising an at least partially transparent optical coupling device located in a front section of said display device and comprising a light guide member for guiding at least one part of the light emitted from the said display area to the corresponding sensor, wherein said coupling device further comprises an incoupling member for coupling the light into the light guide member.

29. The display device according to claim 28, wherein the light guide member is running in a plane which is parallel to a front surface of the display device and wherein the incoupling member is an incoupling member laterally coupling the light into the light guide member of the coupling device.

30. The display device according to claim 28, wherein the light guide member is provided with a spherical or rectangular cross-sectional shape when viewed in a plane normal to the front surface and normal to a main extension of the light guide member.

31. The display device according to claim 30, wherein the incoupling member is cone-shaped.

32. The display device according to claim 21, wherein the incoupling member is formed as a laterally prominent incoupling member, which is delimited by two laterally coaxial aligned cones, said cones having a mutual apex and different apex angles.

33. The display device according to claim 28, wherein the incoupling member is a diffraction grating.

34. The display device according to claim 28, wherein the incoupling member further transforms a wavelength of light emitted from the display area into a sensing wavelength.

35. The display device according to claim 24, wherein the sensing wavelength is in the infrared range, particularly between 0.7 and 3 micrometers.

36. The display device according to claim 24, wherein the incoupling member is provided with a phosphor for said transformation.

37. The display device according to claim 28, wherein the coupling device is part of a cover member having an inner face and an outer face opposed to the inner face, said inner face facing the at least one display area, wherein the coupling device is present at the inner face.

38. The display device according to claim 21, wherein the display device simultaneously displays an image and senses a light property in at least one display area.

39. The display device according to claim 28, wherein the light property is the luminance and wherein color measurements are sensed by the at least one sensor of the display device in a calibration mode.

40. The display device according to claim 28, wherein the light property is the ambient light and wherein color measurements are sensed by the at least one sensor of the display device in a real-time mode.
